(19) United States
(12) Patent Application Publication
(10) Pub. No.: US 2010/0044144 A1
(43) Pub. Date: Feb. 25, 2010

(54) Circular-Shaped Linear Synchronous Motor, Electromagnetic Suspension and Motor-Driven Steering Device Using the Same

(75) Inventors: Fumio Tajima, Hitachi (JP); Masashi Kitamura, Mito (JP); Yusuke Akami, Yokohama (JP); Noriyuki Utsumi, Tokyo (JP); Tomoyuki Lee, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Automotive Systems, Ltd., Hitachinaka-shi (JP)

(21) Appl. No.: 12/508,304

(22) Filed: Jul. 23, 2009

(30) Foreign Application Priority Data
Jul. 25, 2008 (JP) 2008-192637

(51) Int. Cl. B62D 5/04; H02K 41/03; H02P 6/14; B60G 11/00

(52) U.S. Cl. 180/443; 310/12.17; 318/135; 280/124.1

(57) ABSTRACT

Disclosed are a high-damping and high-thrust cylindrical linear motor and a motor-driven power steering device. A stator includes three-phase stator and a stator core. A slider includes a slider core and permanent magnets. The stator core includes stator-core salient poles, two auxiliary poles and yoke units with a small poles on its surface of the side of the slider, the auxiliary poles being deployed at both ends of the stator-core salient poles, the yoke units configuring a magnetic circuit in cooperation with the stator core and the auxiliary poles. The magnetic circuit is shared among the three phases. Polarities of magnets of the slider become an identical polarity, each of the plurality of permanent magnets being positioned at a position which is opposed to each of the plurality of small poles included in one stator-core salient pole out of the plurality of stator-core salient poles.

### BACKGROUND OF THE INVENTION

1. Field of the Invention

The present invention relates to a cylindrical linear motor, or a circular-shaped linear synchronous motor, an electromagnetic suspension and a motor-driven power steering device using the same motor.

2. Description of the Related Art

Consideration is now given to an attempt to suppress fluctuations of vehicles such as Shinkansen-train or automobile by inverter-using a permanent-magnet type three-phase cylindrical linear motor. In this case, even when the inverter has failed, a hydraulic-pressure damper to be adjacently provided with the cylindrical linear motor can be eliminated, or can be made smaller. This configuration change in the hydraulic-pressure damper is made possible if a large damping force can be ensured by short-circuiting terminals among the three phases of the cylindrical linear motor. As a result of this change, it becomes possible to configure the entire electromagnetic suspension using the motor in a small size and at a low cost.

Conventionally, as a linear motor to be used as the motor for an electromagnetic suspension, there has been known the following permanent-magnet type three-phase cylindrical linear synchronous motor (refer to, e.g., JP-A-2006-187079). This three-phase cylindrical linear synchronous motor is configured as follows: Poles are provided on the inner-circumference side of the outer cylinder (i.e., stator) of a double-layer cylinder, then winding a coil between the poles. Also, permanent magnets are attached on the outer-circumference side of the inner cylinder (i.e., slider) of the double-layer cylinder. Moreover, as is disclosed in JP-A-2006-187079 as well, this motor is also configured such that a relationship of 2/3<τm/τp<4/3 is established between the pitch (τm) of the poles and the pole pitch (τp) of the permanent magnets. This configuration allows implementation of the small-sized, high-thrust, and low-thrust-pulsation, or ripple cylindrical linear synchronous motor.

Also, as another cylindrical linear motor, there has been known the following permanent-magnet type three-phase cylindrical linear synchronous motor (refer to, e.g., JP-A-2005-51884). This motor is configured as follows: The poles are configured independently of each other on each U-phase, V-phase, and W-phase basis. Moreover, a relationship of 1/2>τm/τp, i.e., τm/τp<1/2, is established between the pitch (τm) of the poles and the pole pitch (τp) of the permanent magnets.

### SUMMARY OF THE INVENTION

In the linear motor disclosed in JP-A-2006-187079, however, the ratio between the pitch (τm) of the poles and the pole pitch (τp) of the permanent magnets is configured to satisfy the relationship of 2/3<τm/τp<4/3. As a result of this relationship, saturation of magnetic paths of the permanent magnets imposes a limitation on the thrust which the linear motor is capable of exhibiting. Accordingly, there has existed a problem that the linear motor is incapable of exhibiting the high-damping performance.

In the linear motor disclosed in JP-A-2005-51884, the ratio between the pitch (τm) of the poles and the pole pitch (τp) of the permanent magnets is configured to satisfy the relationship of τm/τp<1/2. As a result of this relationship, the frequency is high, and thus magnetic-flux amount of the stator windings need not be increased. This feature makes it possible to increase a slot area which the stator windings occupy, thereby allowing implementation of the linear motor which is equipped with the high-damping characteristics. In the linear motor disclosed in JP-A-2005-51884, however, each of the U phase, V phase, and W phase configures a magnetic circuit independently of each other. Accordingly, a spacer is inserted into between the respective phases, thereby setting up a space which is not associated with the performance. As a result, there has existed a problem that the per-volume thrust and damping performances are reduced.

It is an object of the present invention to provide a high-damping and high-thrust cylindrical linear motor, and an electromagnetic suspension and a motor-driven power steering device using the same linear motor.

The most representative feature of the present invention is as follows: A cylindrical linear motor, including a cylinder-shaped stator, and a cylinder-shaped slider, the slider being deployed via a clearance with respect to the stator, and being linearly movable relative to the stator, wherein the stator includes three-phase stator windings arranged sequentially in a movement direction of the slider, and a stator core deployed among these stator windings, the slider including a slider core, and a plurality of permanent magnets fixed to the slider core and having poles with an equal spacing, the stator core including a plurality of stator-core salient poles, two auxiliary poles, and yoke units, each of the stator-core salient poles having a plurality of small poles on its surface of the side of the slider, the auxiliary poles being deployed at both ends of the stator-core salient poles, the yoke units configuring a magnetic circuit in cooperation with the stator core and the auxiliary poles, the magnetic circuit configured by the stator core being shared among the three phases, the plurality of permanent magnets of the slider being configured such that their polarities become an identical polarity, each of the plurality of permanent magnets being positioned at a position which is opposed to each of the plurality of small poles included in one stator-core salient pole out of the plurality of stator-core salient poles.

Another feature of the present invention is as follows: The cylindrical linear motor is configured such that the magnetic circuit configured by the stator core is shared among the three phases, and such that a pitch of the plurality of small poles of the stator becomes equal to a pitch of the plurality of permanent magnets of the slider.

The most representative feature of a cylindrical linear motor device of the present invention is as follows: A cylindrical linear motor device, including a cylindrical linear motor including a cylinder-shaped stator and a cylinder-shaped slider, the slider being deployed via a clearance with respect to the stator, and being linearly movable relative to the stator, a position sensor for detecting positions of poles of the slider deployed inside a magnetic circuit configured by a stator core, and a control device for calculating the positions of the poles of the slider based on an output of the position sensor, and thereby controlling a current to be supplied to the cylindrical linear motor, wherein the stator of the cylindrical linear motor includes three-phase stator windings arranged sequentially in a movement direction of the slider, and the stator core deployed among these stator windings, the slider including a slider core, and a plurality of permanent magnets fixed to the slider core and having the poles with an equal spacing, the stator core including a plurality of stator-core salient poles, two auxiliary poles, and yoke units, each of the stator-core salient poles having a plurality of small poles on its surface of the side of the slider, the auxiliary poles being deployed at both ends of the stator-core salient poles, the yoke units configuring the magnetic circuit in cooperation with the stator core and the auxiliary poles, the magnetic circuit configured by the stator core being shared among the three phases, the plurality of permanent magnets of the slider being configured such that their polarities become an identical polarity, each of the plurality of permanent magnets being positioned at a position which is opposed to each of the plurality of small poles included in one stator-core salient pole out of the plurality of stator-core salient poles.

Still another feature of the present invention is that these cylindrical linear motors are applied to the electromagnetic suspension and the motor-driven power steering device.

The configuration as described above allows acquisition of the high-damping and high-thrust performance.

According to the present invention, it becomes possible to permit the linear motor and this-motor-used electromagnetic suspension to exhibit the high-damping and high-thrust performance.

### BRIEF DESCRIPTION OF THE DRAWINGS

FIG. 1 is a transverse cross-sectional diagram for illustrating the configuration of a cylindrical linear motor according to a first embodiment of the present invention;

FIG. 2 is an a-a cross-sectional diagram of FIG. 1;

FIG. 3 is a transverse cross-sectional diagram for illustrating the configuration of substantial part of the cylindrical linear motor according to the first embodiment of the present invention;

FIG. 4 is a transverse cross-sectional diagram for illustrating another configuration of the substantial part of the cylindrical linear motor according to the first embodiment of the present invention;

FIG. 5 is a block diagram for illustrating the configuration of a cylindrical linear motor device which uses the cylindrical linear motor according to the first embodiment of the present invention;

FIG. 6 is a block diagram for illustrating the configuration for three-phase short-circuit in the cylindrical linear motor according to the first embodiment of the present invention;

FIG. 7 is a transverse cross-sectional diagram for illustrating another first design configuration of stator-core yokes and stator-core salient poles in the cylindrical linear motor according to the first embodiment of the present invention;

FIG. 8 is a transverse cross-sectional diagram for illustrating another second design configuration of the stator-core yokes and the stator-core salient poles in the cylindrical linear motor according to the first embodiment of the present invention;

FIG. 9 is a transverse cross-sectional diagram for illustrating another third design configuration of the stator-core yokes and the stator-core salient poles in the cylindrical linear motor according to the first embodiment of the present invention;

FIG. 10 is a transverse cross-sectional diagram for illustrating another design configuration of the permanent magnets in the cylindrical linear motor according to the first embodiment of the present invention;

FIG. 11 is a transverse cross-sectional diagram for illustrating another fourth design configuration of stator-core yokes and stator-core salient poles in the cylindrical linear motor according to the first embodiment of the present invention;

FIG. 12 is a transverse cross-sectional diagram for illustrating another fifth design configuration of the stator-core yokes and the stator-core salient poles in the cylindrical linear motor according to the first embodiment of the present invention;

FIG. 13 is a transverse cross-sectional diagram for illustrating another sixth design configuration of the stator-core yokes and the stator-core salient poles in the cylindrical linear motor according to the first embodiment of the present invention;

FIG. 14 is a transverse cross-sectional diagram for illustrating the configuration of the cylindrical linear motor according to a second embodiment of the present invention;

FIG. 15 is a transverse cross-sectional diagram for illustrating the configuration of the cylindrical linear motor according to a third embodiment of the present invention;

FIG. 16 is a block diagram for illustrating the configuration of the cylindrical linear motor device which uses the cylindrical linear motor according to the third embodiment of the present invention;

FIG. 17 is an explanatory diagram for explaining the correction principle of output information of a pole-position sensor in the cylindrical linear motor device which uses the cylindrical linear motor according to the third embodiment of the present invention;

FIG. 18 is a block diagram for illustrating the configuration of a sensor-output correction circuit used in the cylindrical linear motor device which uses the cylindrical linear motor according to the third embodiment of the present invention;

FIG. 19A to FIG. 19C are explanatory diagrams for explaining the operation and correction result of the sensor-output correction circuit used in the cylindrical linear motor device which uses the cylindrical linear motor according to the third embodiment of the present invention;

FIG. 20A to FIG. 20C are explanatory diagram for explaining the operation and correction result of the sensor-output correction circuit used in the cylindrical linear motor device which uses the cylindrical linear motor according to the third embodiment of the present invention;

FIG. 21 is a configuration diagram of a railroad vehicle where the cylindrical linear motor according to each embodiment of the present invention is used as an electromagnetic suspension; and

FIG. 22 is a configuration diagram of a rack-&-pinion scheme motor-driven power steering device to which the cylindrical linear motor according to each embodiment of the present invention is applied.

### DESCRIPTION OF THE INVENTION

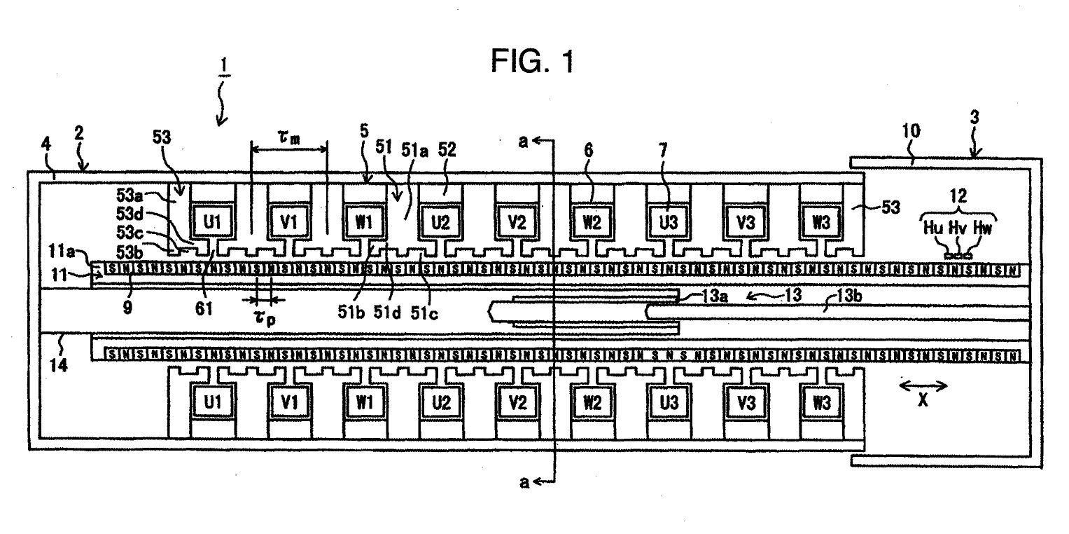

Hereinafter, referring to FIG. 1 to FIG. 13, the explanation will be given below concerning the configuration of a cylindrical linear motor according to a first embodiment of the present invention.

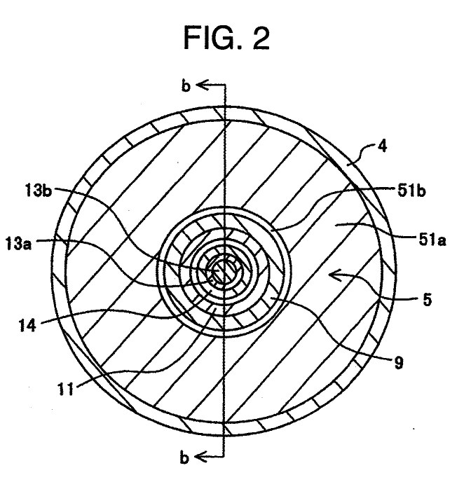

First, referring to FIG. 1 and FIG. 2, the explanation will be given below regarding the entire configuration of the cylindrical linear motor according to the present embodiment.

FIG. 1 is a transverse cross-sectional diagram for illustrating the configuration of the cylindrical linear motor according to the first embodiment of the present invention. FIG. 2 is an a-a cross-sectional diagram of FIG. 1. Also, FIG. 1 is a b-b cross-sectional diagram of FIG. 2.

As illustrated in FIG. 1, the permanent-magnet type three-phase cylindrical linear motor 1 according to the present embodiment includes a cylinder-shaped stator 2, and a cylinder-shaped slider 3 which is held in a slidably movable manner inside the stator 2.

The stator 2 includes a stator case 4, a stator core 5, three-phase stator windings 7, and a stator inner case 14. Also, for the purpose of heat-liberation, concave-convex portions (not-illustrated) are formed along the outer circumference of the stator case 4. The stator core 5 is fixed onto the inner-circumference side of the stator case 4. The stator case 4 is formed into the above-described cylinder shape by dividing a bottom-equipped cylinder into two portions in the axial direction, and bonding the two portions at the division surfaces. The stator 2 is configured by deploying respective configuration components of the stator 2 (i.e., stator-core yokes 52, stator-core salient poles 51, the three-phase stator windings 7, and auxiliary poles 53, which will be described later) into one of the half-divided stator cases, and overlaying the remaining other half-divided stator case thereon.

In the illustrated embodiment, the stator core 5 includes the nine units of ring-shaped stator-core yokes 52, the eight units of ring-shaped stator-core salient poles 51, and the two units of ring-shaped auxiliary poles 53. The stator core 5 is configured such that the stator-core yokes 52 and the stator-core salient poles 51 are multi-layered alternately, and such that the auxiliary poles 53 are multi-layered on both sides of this resultant multi-layered element. The stator-core yokes 52, the stator-core salient poles 51, and the auxiliary poles 53 are composed of iron all. The stator-core salient poles 51 are so configured as to be separated from the stator-core yokes 52. As a result, forming both of them as the comparatively simple ring configuration is advisable enough, as compared with a case where both of them are formed integrally. This feature allows an enhancement in their fabrication property. Incidentally, compacted powder, which is produced by compressing and solidifying iron powder, can also be used as the stator-core salient poles 51, the stator-core yokes 52, and the auxiliary poles 53. The use of the compacted powder makes it possible to increase the resistance value of stator teeth, and to reduce an eddy-current loss, thereby allowing implementation of an increase in the thrust to occur.

The stator-core yokes 52 and the stator-core salient poles 51 are deployed in the alternately multi-layered manner. Moreover, the auxiliary poles 53 are deployed on both ends of this resultant multi-layered component. These deployments allow implementation of a magnetic circuit on the side of the stator 2.

The nine units of three-phase stator windings 7 (: U1, U2, U3, V1, V2, V3, W1, W2, W3) are deployed inside nine units of slots 6. Each of the nine units of slots 6 is formed by a stator-core yoke 52 and stator-core salient poles 51 positioned on both sides thereof; otherwise, by a stator-core salient pole 51 positioned on one side of a stator-core yoke 52 and an auxiliary pole 53 positioned on the other side thereof. Incidentally, although not illustrated, electrical insulation among the three-phase stator windings 7, the stator-core salient poles 51, and the stator-core yokes 52 is implemented using an appropriate insulating unit (e.g., insulating paper, varnish).

The three-phase stator windings 7 used are formed by winding a copper wiring, whose surface is enamel-coated, a plurality of turns into a ring-shaped configuration. Here, each winding used is wound in one and the same direction. Incidentally, the use of windings such as rectangular wiring allows an enhancement in volume-occupation ratio of the stator windings 7 inside each slot 6, thereby making it possible to make a contribution to an enhancement in the thrust and the high-damping implementation. It is assumed that U1, U2, and U3 of the stator windings 7 are connected to the U phase, V1, V2, and V3 thereof are connected to the V phase, and W1, W2, and W3 thereof are connected to the W phase, respectively. Here, the U-phase, V-phase, and W-phase windings are star-connected generally.

Moreover, each of the stator-core salient poles 51 includes a stator-core tooth 51a, stator-core small poles 51b, stator-core small pole slits 51c, and a stator-core small pole yoke 51d. The stator-core tooth 51a is a component which, of each stator-core salient pole 51, is positioned on the outer-circumference side and in proximity to the central portion. The stator-core tooth 51a forms a magnetic path in cooperation with the stator-core yokes 52. The stator-core small poles 51b are convex-shaped components which, of each stator-core salient pole 51, are positioned at a portion situated on the inner-circumference side and opposed to the slider 3. In the illustrated embodiment, the one unit of stator-core salient pole 51 includes the three units of stator-core small poles 51b. The stator-core small pole yoke 51d is a component for magnetically connecting the stator-core small poles 51b and the stator-core tooth 51a to each other. The stator-core small pole slits 51c are concave-shaped components which, of each stator-core salient pole 51, are positioned at the portion situated on the inner-circumference side and opposed to the slider 3. The stator-core small pole slits 51c are formed by the stator-core small poles 51b and the stator-core small pole yoke 51d. When there exist the three units of stator-core small poles 51b, there exist the two units of stator-core small pole slits 51c. The stator-core tooth 51a, the stator-core small poles 51b, the stator-core small pole slits 51c, and the stator-core small pole yoke 51d are formed integrally, thereby configuring each stator-core salient pole 51.

Each of the slots 6 is formed in the space surrounded by between the adjacent stator-core salient poles 51 and each of the stator-core yokes 52. The three-phase stator windings 7 are deployed inside the slots 6. Also, each of slits 61 is formed in each slot 6 on the side of the slider 3. Each slit 61 plays a role of preventing occurrence of a magnetic short-circuit between the adjacent stator-core salient poles 51.

Meanwhile, each of the auxiliary poles 53 includes an auxiliary-pole tooth 53a, auxiliary-pole small poles 53b, auxiliary-pole small pole slits 53c, and an auxiliary-pole small pole yoke 53d. The auxiliary-pole tooth 53a is a component which, of each auxiliary pole 53, is positioned on the outer-circumference side and in proximity to the central portion. The auxiliary-pole tooth 53a forms a magnetic path in cooperation with the stator-core yokes 52. The auxiliary-pole small poles 53b are convex-shaped components which, of each auxiliary pole 53, are positioned at a portion situated on the inner-circumference side and opposed to the slider 3. In the illustrated embodiment, the one unit of auxiliary pole 53 includes the two units of auxiliary-pole small poles 53b. The auxiliary-pole small pole yoke 53d is a component for magnetically connecting the auxiliary-pole small poles 53b and the stator-core tooth 51a to each other. The auxiliary-pole small pole slits 53c are concave-shaped components which, of each auxiliary pole 53, are positioned at the portion situated on the inner-circumference side and opposed to the slider 3. The auxiliary-pole small pole slits 53c are formed by the auxiliary-pole small poles 53b and the auxiliary-pole small pole yoke 53d. When there exist the two units of auxiliary-pole small poles 53b, there exists the one unit of auxiliary-pole small pole slit 53c. The auxiliary-pole tooth 53a, the auxiliary-pole small poles 53b, the auxiliary-pole small pole slits 53c, and the auxiliary-pole small pole yoke 53d are formed integrally, thereby configuring each auxiliary pole 53.

The auxiliary poles 53 form the stator magnetic path in cooperation with the stator-core salient poles 51 and the stator-core yokes 52. In particular, the auxiliary poles 53 play an important role of reducing the pulsation thrust including cogging.

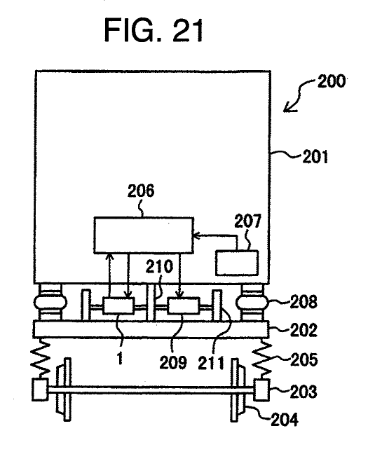

Next, the slider 3 includes a slider case 10, a slider core 11, and sixty-four units of permanent magnets 9. The slider case 10 is of the bottom-equipped cylinder shape, and its inner diameter is larger than the outer diameter of the stator case 4. Also, a mounting unit (not illustrated) is fixed onto the outer-end surface of the slider case 10 on the bottom side. The mounting unit is a part used for mounting the slider case onto a vehicle body or a vehicle truck in the case of a vehicle which will be described later referring to FIG. 21.

The slider core 11 is fixed onto the bottom of the slider case 10, and is of the cylinder shape. The sixty-four units of permanent magnets 9 are of the ring shape, and are mounted on the outer-circumference side of the slider core 11 with an equal length set thereto mutually. The polarity of the adjacent permanent magnets 9 is configured such that an N pole and an S pole are arranged alternately in the axial direction. A slider-core protrusion unit 11a, which is formed on both ends of the slider core 11, prevents the permanent magnets 9 from moving in the axial direction. Incidentally, here, the polarity of a permanent magnet 9 being the N pole means that the ring-shaped magnet whose outer-circumference side is magnetized into the N pole, and whose inner-circumference side is magnetized into the S pole. Also, the polarity of a permanent magnet 9 being the S pole means that the ring-shaped magnet whose outer-circumference side is magnetized into the S pole, and whose inner-circumference side is magnetized into the N pole.

A predetermined clearance is provided between the outer-circumference side of the permanent magnets 9 and the inner-circumference side of the stator-core salient poles 51. This clearance permits the slider 3 to perform a reciprocating motion inside the stator 2 in such a manner that the slider 3 is in no contact with the stator 2 in the axial direction.

Also, a pole-position sensor 12, which is configured from three units of hole elements Hu, Hv, and Hw, is provided in proximity to the outer circumference of the permanent magnet positioned at the end portion of the slider 3. The three units of hole elements Hu, Hv, and Hw detect the pole positions of the U phase, V phase, and W phase, respectively.

Also, a stroke-sensor stator 13a is provided at the end portion of the stator inner case 14 on the slider side. A rod-shaped stroke-sensor slider 13b is provided at the bottom of the slider case 10 of the slider 3. Both of the stroke-sensor stator 13a and the stroke-sensor slider 13b configure a stroke sensor 13. The stroke sensor 13 is a linear sensor for detecting the movement amount of the slider 3 relative to the stator 2 in the X direction. The stroke sensor 13 detects the absolute position (i.e., stroke) using, e.g., a potentiometer. Also, a non-contact sensor using reactance is available as the stroke sensor. Moreover, the stroke sensor can be substituted for the pole-position sensor. Meanwhile, the pole-position sensor can be substituted for the stroke sensor.

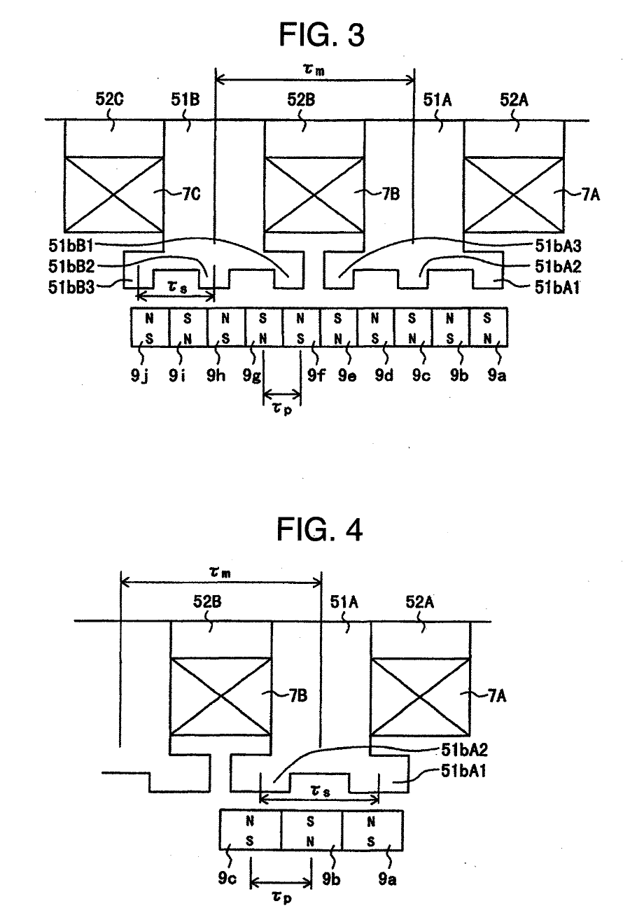

Next, referring to FIG. 3, the explanation will be given below concerning the relationship between the stator-core salient poles 51 and the permanent magnets 9 in the cylindrical linear motor according to the present embodiment.

FIG. 3 is a transverse cross-sectional diagram for illustrating the configuration of substantial part of the cylindrical linear motor according to the first embodiment of the present invention. Incidentally, the same reference numerals as the ones in FIG. 1 denote the same configuration components.

Here, as the substantial part of the stator-core salient poles 51 illustrated in FIG. 1, the illustration is given to three units of stator-core yokes 52A, 52B, and 52C, two units of stator-core salient poles 51A and 51B, and three units of stator windings 7A, 7B, and 7C. The stator-core salient pole 51A includes three units of stator-core small poles 51bA1, 51bA2, and 51bA3. Also, the stator-core salient pole 51B includes three units of stator-core small poles 51bB1, 51bB2, and 51bB3. Furthermore, as the substantial part of the permanent magnets 9 illustrated in FIG. 1, the illustration is given to ten units of permanent magnets 9a, 9b, 9c, 9d, 9e, 9f, 9g, 9h, 9i, and 9j.

Here, in the present embodiment, the pitch τs between the adjacent stator-core small poles 51b is equal to two times as long as the pitch τp between the centers of the adjacent permanent magnets 9. Accordingly, when, for example, the S-pole permanent magnet 9a is opposed to the stator-core small pole 51bA1 of the stator-core salient pole 51A, the S-pole permanent magnets 9c and 9e are opposed to the stator-core small poles 51bA2 and 51bA3 of the stator-core salient pole 51A, respectively. Namely, in the present embodiment, the one unit of stator-core salient pole 51A includes the three units of stator-core small poles 51bA1, 51bA2, and 51bA3. Simultaneously therewith, the three units of permanent magnets 9a, 9c, and 9e opposed to these stator-core small poles 51bA1, 51bA2, and 51bA3 come to possess the same pole, i.e., the S pole. Also, the adjacent one unit of stator-core salient pole 51B includes the three units of stator-core small poles 51bB1, 51bB2, and 51bB3. Simultaneously therewith, the three units of permanent magnets 9f, 9h, and 9j opposed to these stator-core small poles 51bB1, 51bB2, and 51bB3 come to possess the same pole, i.e., the N pole.

Here, in the present embodiment, it is assumed that the distance (i.e., pitch) between the centers of the adjacent stator-core salient poles 51 is equal to τm, and the distance (i.e., pitch) between the centers of the adjacent permanent magnets 9 is equal to τp. Here, the configuration is set such that the one unit of stator-core salient pole 51 is accompanied by the three units of stator-core small poles 51b. As a result of this configuration, the following Expression (1) holds between τm, i.e., the distance between the centers of the adjacent stator-core salient poles 51, and τp, i.e., the distance between the centers of the adjacent permanent magnets 9:

τm=τp·(5+1/3)=16/3·τp (1)

Accordingly, τm, i.e., the distance (i.e., pitch) between the centers of the adjacent stator-core salient poles 51, becomes equal to 16/3·τp. Taking the periodicity into consideration, this distance becomes equivalent to a 240-° angular interval in terms of the electric angle. Consequently, it turns out that the following principle is established: The right-oriented movement of the slider in the axial direction causes induced voltages to occur in the U phase, V phase, and W phase of the stator windings 7. Here, phases of the induced voltages are shifted by 120° to each other in terms of the electric angle.

Incidentally, the above-described description is about the case where the one unit of stator-core salient pole 51 is accompanied by the three units of stator-core small poles 51b. The following two cases, however, are also implementable: A case where the one unit of stator-core salient pole 51 is accompanied by the two units of stator-core small poles 51b, and a case where the one unit of stator-core salient pole 51 is accompanied by the four units of stator-core small poles 51b.

In the case where the one unit of stator-core salient pole 51 is accompanied by the two units of stator-core small poles 51b, an Expression τm=10/3·τp holds. Also, in the case where the one unit of stator-core salient pole 51 is accompanied by the four units of stator-core small poles 51b, an Expression τm 22/3·τp holds.

Here, rewriting the above-described Expressions results in establishments of the following Expressions: τm/τp=16/3 in the case where the one unit of stator-core salient pole 51 is accompanied by the three units of stator-core small poles 51b, τm/τp=10/3 in the case where the one unit of stator-core salient pole 51 is accompanied by the two units of stator-core small poles 51b, and τm/τp=22/3 in the case where the one unit of stator-core salient pole 51 is accompanied by the four units of stator-core small poles 51b.

On the other hand, in JP-A-2006-187079 described earlier, the configuration is set such that 2/3<τm/τp<4/3 is established. Also, in JP-A-2005-51884 described earlier, the configuration is set such that τm/τp<1/2 is established. Namely, in the present embodiment, the value of τm/lp is made larger as compared with the configurations in JP-A-2006-187079 and JP-A-2005-51884.

As described above, the voltages having been induced due to movement of the slider, whose phases are shifted by 120° to each other in terms of the electric angle, occur in the U phase, V phase, and W phase of the stator windings 7. As a consequence, a continuous thrust can be generated in the axial direction by passing a current, whose phase is shifted by 120° in terms of the electric angle, through the stator windings 7 using a control device which will be described later.

In the above-described cylindrical linear motor 1 including the stator 2 and the slider 3, an electromagnetic suspension is configured by further providing a control device for controlling the thrust to occur by controlling a current which is to be passed through the stator windings 7. The configuration of the control device will be described later. Here, the electromagnetic suspension can be used for preventing fluctuation of a railroad vehicle in particular. In this case, a mounting unit (not illustrated) at the end portion of the stator 2 in the axial direction is mounted onto the vehicle body, and a mounting unit (not illustrated) at the end portion of the slider 2 in the axial direction is mounted onto the vehicle truck. This mounting scheme permits the electromagnetic suspension to function.

Next, the explanation will be given below concerning the principle based on which the above-described configuration allows acquisition of the high-damping performance.

Based on the configuration in the present embodiment illustrated in FIG. 1, it is conceivable that the magnetic-flux density in the clearance between the slider 3 and the stator 2 changes in a sinusoidal-wave-like manner with its maximum value Bg. Then, the maximum value φm1 of the magnetic flux passing through the one unit of stator-core salient pole 51 is represented by the following Expression (2), letting the area of the one unit of stator-core salient pole 51 on the inner-circumference side be equal to Am:

φm1=2/π·Am·3/5·Bg (2)

On the other hand, in the configuration disclosed in JP-A-2006-187079, the maximum value φm2 of the magnetic flux passing through the one unit of stator-core salient pole 51 is represented by the following Expression (3):

φm2=2/π·Am·Bg (3)

It is conceivable that about the one-half of the magnetic flux passing through the stator-core salient pole 51 comes into linkage with each stator winding 7.

Here, consideration is given to an induced voltage E. In general, the induced voltage E is represented by the following Expression (4):

E=k1·φm·P (4)

where k1 is a constant, and P is the pole number.

Here, the pole number P1 of the cylindrical linear motor according to the present embodiment is equal to 48. Meanwhile, the pole number P2 of the cylindrical linear motor disclosed in JP-A-2006-187079 is equal to 9. Accordingly, the ratio (i.e., P1/P2) between both of the pole numbers is equal to 48/9, which becomes equal to about 5. Moreover, the ratio (i.e., E1/E2) between the induced voltage E1 generated by the cylindrical linear motor according to the present embodiment and the induced voltage E2 generated by the cylindrical linear motor disclosed in JP-A-2006-187079 can be expressed as 3P1/5P2m, which becomes equal to 48/15. Consequently, the induced voltage E1 generated by the cylindrical linear motor according to the present embodiment becomes equal to about three times as high as the induced voltage E2 generated by the cylindrical linear motor disclosed in JP-A-2006-187079.

Incidentally, actually, the magnetic flux passing from the permanent magnets 9 through the stator-core small poles 51b returns after having passed through the stator-core small pole yoke 51d and the stator-core small pole slits 51c. As a result, the magnetic flux does not come into linkage with the stator windings 7. Consequently, the above-described ratio does not become so large the value as is described above. As described earlier, however, it becomes possible to heighten the induced voltage, and to increase the power-generation constant Ke. Since the damping force becomes increasingly large in proportion to (Ke²/R), it becomes possible to increase the damping force.

Also, the winding resistance R according to the present embodiment and the one according to JP-A-2006-187079 are basically identical to each other. In the present embodiment, however, the magnetic circuit makes it possible to reduce the magnetic flux which passes through the stator-core salient poles 51. Accordingly, it becomes possible to narrow the cross-sectional area of the magnetic path of the stator 2 and the slider 3. As a result, it becomes possible to increase the cross-sectional design configuration of each slot, and to lower the resistance R. Since the damping force becomes increasingly large in proportion to (Ke²/R), it becomes possible to increase the damping force by lowering the resistance R.

Next, referring to FIG. 4, the explanation will be given below regarding another configuration of the relationship between the stator-core salient poles 51 and the permanent magnets 9 in the cylindrical linear motor according to the present embodiment.

FIG. 4 is a transverse cross-sectional diagram for illustrating another configuration of the substantial part of the cylindrical linear motor according to the first embodiment of the present invention. Incidentally, the same reference numerals as the ones in FIG. 1 and FIG. 3 denote the same configuration components.

Here, the stator-core salient pole 51A includes the two units of stator-core small poles 51bA1 and 51bA2. Also, as the permanent magnets 9, the illustration is given to the three units of permanent magnets 9a, 9b, and 9c.

In this case, the pitch TS between the adjacent stator-core small poles 51b is equal to two times as long as the pitch τp between the centers of the adjacent permanent magnets 9. Accordingly, when, for example, the N-pole permanent magnet 9a is opposed to the stator-core small pole 51bA1 of the stator-core salient pole 51A, the N-pole permanent magnet 9c is opposed to the stator-core small pole 51bA2 of the stator-core salient pole 51A. Namely, in the present embodiment, the one unit of stator-core salient pole 51A includes the two units of stator-core small poles 51bA1 and 51bA2. Simultaneously therewith, the two units of permanent magnets 9a and 9c opposed to these stator-core small poles 51bA1 and 51bA2 come to possess the same pole, i.e., the N pole.

Here, in the present embodiment, it is assumed that the distance (i.e., pitch) between the centers of the adjacent stator-core salient poles 51 is equal to τm, and the distance (i.e., pitch) between the centers of the adjacent permanent magnets 9 is equal to τp. Here, the configuration is set such that the one unit of stator-core salient pole 51 is accompanied by the two units of stator-core small poles 51b. As a result of this configuration, τm=10/3·τp holds between τm, i.e., the distance between the centers of the adjacent stator-core salient poles 51, and τp, i.e., the distance between the centers of the adjacent permanent magnets 9.

Accordingly, τm, i.e., the distance (i.e., pitch) between the centers of the adjacent stator-core salient poles 51, becomes equal to 10/3·τp. Taking the periodicity into consideration, this distance becomes equivalent to a 240-° angular interval in terms of the electric angle. Consequently, it turns out that the following principle is established: The right-oriented movement of the slider in the axial direction causes induced voltages to occur in the U phase, V phase, and W phase of the stator windings 7. Here, phases of the induced voltages are shifted by 120° to each other in terms of the electric angle.

As described above, the induced voltages, whose phases are shifted by 120° to each other in terms of the electric angle, occur in the U phase, V phase, and W phase of the stator windings 7. As a consequence, the continuous thrust can be generated in the axial direction by passing the current, whose phase is shifted by 120° in terms of the electric angle, through the stator windings 7 using the control device which will be described later.

In this example as well, in comparison with the conventional embodiments, the induced voltage E1 generated by the cylindrical linear motor according to the present embodiment can be made higher than the induced voltage E2 generated by the cylindrical linear motor disclosed in JP-A-2006-187079. This feature makes it possible to increase the power-generation constant Ke. Consequently, it becomes possible to increase the damping force.

Also, in the linear motor disclosed in JP-A-2005-51884, each of the U phase, V phase, and W phase configures a magnetic circuit independently of each other. Namely, as described in <FIG. 1>, <FIG. 3>, and the paragraph number <0028> of JP-A-2005-51884, a toroidal coil 2 in the U phase is held by being sandwiched between a pair of armature yokes 1. Also, a toroidal coil 2 in the V phase is held by being sandwiched between a pair of armature yokes 1. Moreover, a toroidal coil 2 in the W phase is held by being sandwiched between a pair of armature yokes 1. Furthermore, a spacer is inserted into between the U-phase-dedicated armature yoke and the V-phase-dedicated armature yoke, thereby setting up a clearance therebetween. In this way, the spacer is inserted into between the respective phases, thereby providing the space which is not associated with the performance. As a consequence, the per-volume thrust and damping performances are reduced.

On the other hand, in the present embodiment, the magnetic circuit in the U phase, the magnetic circuit in the V phase, and the magnetic circuit in the W phase are shared. For example, in the example illustrated in FIG. 3, assuming that the stator winding 7A is the winding in the W phase, the stator winding 7B is the winding in the V phase, and the stator winding 7C is the winding in the U phase, the stator-core salient pole 51A is shared between the W phase and the V phase, thereby configuring the magnetic circuit. Also, the stator-core salient pole 51B is shared between the V phase and the U phase, thereby configuring the magnetic circuit. In this way, the unnecessary space is not formed by sharing the U-phase magnetic circuit, the V-phase magnetic circuit, and the W-phase magnetic circuit. As a consequence, the per-volume thrust and damping performances are enhanced.

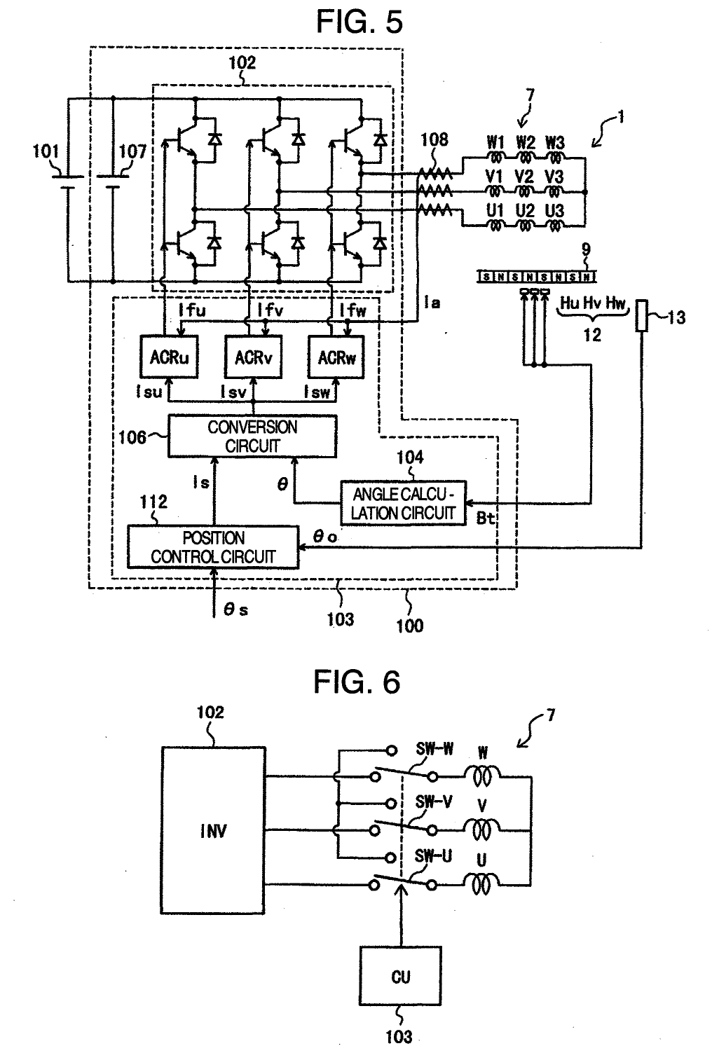

Next, referring to FIG. 5, the explanation will be given below concerning the configuration of a cylindrical linear motor device which uses the cylindrical linear motor according to the present embodiment.

FIG. 5 is a block diagram for illustrating the configuration of the cylindrical linear motor device which uses the cylindrical linear motor according to the first embodiment of the present invention. Incidentally, the same reference numerals as the ones in FIG. 1 and FIG. 3 denote the same configuration components.

The cylindrical linear motor device according to the present embodiment includes the cylindrical linear motor 1, a DC power-supply 101 which configures a driving power-supply for the cylindrical linear motor 1, and a control device 100 for controlling the driving for the cylindrical linear motor 1 by controlling a power to be supplied to the cylindrical linear motor 1.

The DC power-supply 101 is a device capable of supplying the DC power.

The control device 100 is an inverter device for converting the DC power supplied from the DC power-supply 101 into a predetermined AC power, and supplying the AC power to the stator windings 7.

The control device 100 includes a power-system inverter circuit 102 (i.e., power conversion circuit) which is electrically connected to between the DC power-supply 101 and the stator windings 7, and a control circuit 103 for controlling the operation of the inverter circuit 102.

The inverter circuit 102 is a bridge circuit configured from switching-use semiconductor elements (e.g., MOS-FETs: Metal-Oxide-Semiconductor Field-Effect Transistors, IGBTs: Insulated-Gate Bipolar Transistors). The bridge circuit is configured such that in-series circuits, which are referred to as “arms”, are electrically connected to each other in parallel by the amount of the phase number (i.e., three, since the present embodiment is of the three phases) of the cylindrical linear motor 1. Each arm is configured such that the switching-use semiconductor element on the upper side and the switching-use semiconductor element on the lower side are electrically connected to each other in series. The higher-potential-side circuit terminal of each arm is electrically connected to the positive-pole side of the DC power-supply 101, and the lower-potential-side circuit terminal of each arm is electrically connected to the negative-pole side of the DC power-supply 101. The midpoint (i.e., connection point of the switching-use semiconductor element on the upper side and the switching-use semiconductor element on the lower side) of each arm is electrically connected to the corresponding-phase windings (: U1, U2, U3; V1, V2, V3; W1, W2, W3) of the stator windings 7.

A smoothing capacitor 107 is electrically connected to between the DC power-supply 101 and the inverter circuit 102. A current sensor 108 is provided between the inverter circuit 102 and the stator windings 7. The current sensor 108, which is configured from appliances such as current transformer, is used for detecting the DC current which flows in each phase.

The control circuit 103 controls operation (i.e., ON/OFF) of the switching-use semiconductor elements of the inverter circuit 102 on the basis of input information. The input information inputted into the control circuit 103 are a requested thrust (current command signal Is) for the cylindrical linear motor 1, and pole position θ of the slider 3 of the cylindrical linear motor 1. The requested thrust (current command signal Is) is command information which is outputted from a higher-order position control circuit in accordance with the request amount requested for the to-be-driven element. The pole position e is detection information which is acquired from the output of the pole-position sensor 12. Here, as illustrated in FIG. 5, the higher-order position control circuit 112 creates the current command signal Is from position information θo and a position command θs transmitted from the stroke sensor 13.

In FIG. 5, an angle calculation circuit 104 outputs the pole position θ on the basis of the signal transmitted from the hole elements Hu, Hv, and Hw which configure the pole-position sensor 12. Based on the pole position θ, a conversion circuit 106 converts the current command signal Is into each-phase current command values Isu, Isv, and Isw in accordance with a sinusoidal-wave output in the same phase as the each-phase induced voltages of the stator windings 7, or the sinusoidal-wave output which has undergone a phase shift. Then, the conversion circuit 106 outputs the each-phase current command values Isu, Isv, and Isw to each-phase current control systems (ACR) 105.

The each-phase current command values Isu, Isv, and Isw outputted from the conversion circuit 106 are inputted into the corresponding-phase current control systems (ACR) 105. In addition to the each-phase current command values, output signals Ifu, Ifv, and Ifw outputted from the corresponding-phase current sensor 108 are inputted into the each-phase current control systems (ACR) 105. Based on each-phase current values obtained from the output signals Ifu, Ifv, and Ifw outputted from the corresponding-phase current sensor 108, and the corresponding-phase current command values Isu, Isv, and Isw, the each-phase current control systems (ACR) 105 output driving signals for driving the switching-use semiconductor elements of the corresponding-phase arms of the inverter circuit 102.

The driving signals outputted from the each-phase current control systems (ACR) 105 are inputted into the control terminals of the switching-use semiconductor elements which configure the corresponding-phase arms of the inverter circuit 102. This input of the driving signals causes each switching-use semiconductor element to perform its ON/OFF operation. As a consequence, the DC power supplied from the DC power-supply 101 is converted into the AC power, then being supplied to the corresponding-phase windings of the stator windings 7.

In the inverter device according to the present embodiment, the currents flowing through the stator windings 7 (i.e., the phase currents flowing through the each-phase windings) are always created in such a manner that a resultant composite vector of armature magnetomotive forces generated by the currents flowing through the stator windings 7 becomes perpendicular with respect to the direction of the magnetic flux or magnetic field generated by the permanent magnets 9, or in such a manner that the resultant composite vector of the armature magnetomotive forces generated by the currents flowing through the stator windings 7 undergoes a phase shift (namely, the resultant composite vector advances by 90° or more (in terms of the electric angle) with respect to the direction of the magnetic flux or magnetic field generated by the permanent magnets 9). On account of this feature, in the permanent-magnet type rotating electrical device of the present embodiment, the use of the non-commutator (i.e., brushless) cylindrical linear motor 1 makes it possible to acquire the characteristics which are equivalent to the ones of the DC linear motor. Incidentally, the above-described control, namely, the currents flowing through the stator windings 7 (i.e., the phase currents flowing through the each-phase windings) are always created in such a manner that the resultant composite vector of the armature magnetomotive forces generated by the currents flowing through the stator windings 7 advances by 90° or more (in terms of the electric angle) with respect to the direction of the magnetic flux or magnetic field generated by the permanent magnets 9, is referred to as “field-weakening control”.

The inverter device according to the present embodiment is used when the high-speed driving for the cylindrical linear motor 1 is implemented using a limited DC voltage.

Accordingly, in the cylindrical linear motor device according to the present embodiment, the currents flowing through the stator windings 7 (i.e., the phase currents flowing through the each-phase windings) are controlled based on the pole position of the slider 3 in such a manner that the resultant composite vector of the armature magnetomotive forces generated by the currents flowing through the stator windings 7 becomes perpendicular with respect to the direction of the magnetic flux or magnetic field generated by the permanent magnets 9. The execution of this control permits the maximum thrust to be outputted continuously from the cylindrical linear motor 1. When the field-weakening control is necessary, it is advisable enough to control the currents flowing through the stator windings 7 (i.e., the phase currents flowing through the each-phase windings) based on the pole position of the slider 3 in such a manner that the resultant composite vector of the armature magnetomotive forces generated by the currents flowing through the stator windings 7 advances by 90° or more (in terms of the electric angle) with respect to the direction of the magnetic flux or magnetic field generated by the permanent magnets 9.

Also, in the cylindrical linear motor 1 according to the present embodiment, the waveforms of the voltages induced in the each-phase windings of the stator windings 7 become the sinusoidal waveform. This is attributed to a phenomenon that the magnetic-density distribution in the clearance between the stator 2 and the slider 3 naturally becomes the sinusoidal-wave-shaped distribution by the fact that the pole number of the permanent magnets 9 in the cylindrical linear motor 1 illustrated in FIG. 1 is made larger. In the inverter device according to the present embodiment, the sinusoidal-wave currents in accordance with the pole position of the slider 3 are passed through the each-phase windings of the stator windings 7 by 180° (in terms of the electric angle) with respect to the above-described sinusoidal-wave induced voltages.

Consequently, in the cylindrical linear motor device according to the present embodiment, the variation in the outputted thrust of the cylindrical linear motor 1 can be suppressed down to a small value by the above-described configuration and control.

Next, referring to FIG. 6, the explanation will be given below regarding the configuration for three-phase short-circuit in the cylindrical linear motor according to the first embodiment of the present invention.

FIG. 6 is a block diagram for illustrating the configuration for the three-phase short-circuit in the cylindrical linear motor according to the first embodiment of the present invention. Incidentally, the same reference numerals as the ones in FIG. 1, FIG. 3, and FIG. 5 denote the same configuration components.

If the inverter circuit 102 illustrated in FIG. 5 fails, the inter-three-phase terminals of the cylindrical linear motor need to be short-circuited in order to allow the cylindrical linear motor to generate the high damping.

For implementing this short-circuit, as illustrated in FIG. 6, a switch SW-u, a switch SW-v, and a switch SW-w are provided between the inverter circuit 102 and the each-phase coils U, V, and W of the stator windings 7. Each of the switches SW-u, SW-v, and SW-w possesses two contact points, respectively. One of the two contact points is connected to a three-phase output terminal of the inverter circuit 102, and the other contact points of the respective switches SW-u, SW-v, and SW-w are connected to each other.

Usually, the switches SW-u, SW-v, and SW-w are switched in such a manner that the inverter circuit 102 is connected to the each-phase coils U, V, and W of the stator windings 7.

If the control circuit 103 judges that the inverter circuit 102 fails, the control circuit 103 switches the switches SW-u, SW-v, and SW-w, thereby establishing the short-circuit of the each-phase coils U, V, and W of the stator windings 7. This short-circuit causes the cylindrical linear motor to generate the high damping.

At the time of preventing the fluctuation of a vehicle, the high damping is acquired by establishing the three-phase short-circuit of the stator windings 7. This makes it possible to omit a damper which is usually equipped with the vehicle.

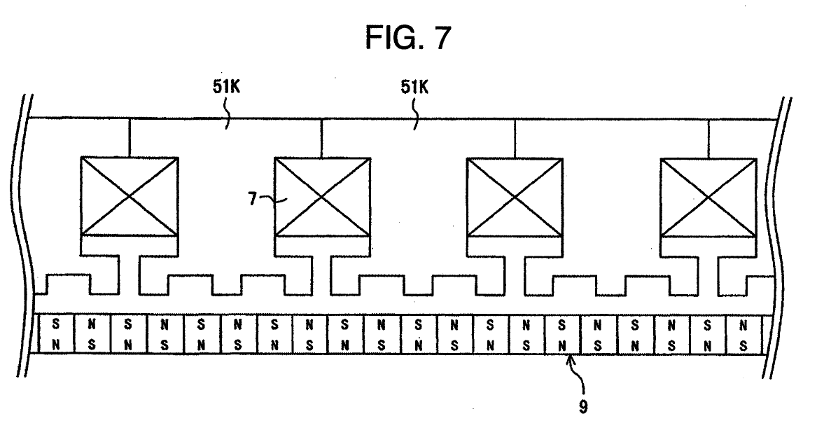

Next, referring to FIG. 7 to FIG. 13, the explanation will be given below concerning other design configurations of the stator-core yokes 52, the stator-core salient poles 51, and the auxiliary poles 53 in the cylindrical linear motor according to the present embodiment.

The stator core 5 illustrated in FIG. 1 is the component for conveying, to the stator case 4, the thrust which the cylindrical linear motor according to the present embodiment generates. Also, the stator core 5 is the component for transmitting heat which occurs in the stator windings 7. Accordingly, the ring-shaped stator-core yokes 52, stator-core salient poles 51, and auxiliary poles 53 need to be configured in such a manner that the coaxial degree is maintained with no clearance present in the axial direction.

Hereinafter, the explanation will be given below concerning the other design configurations of the stator-core yokes, the stator-core salient poles, and the auxiliary poles which allow implementation of the coaxial degree.

First, referring to FIG. 7, the explanation will be given below regarding another first design configuration of the stator-core yokes, the stator-core salient poles, and the auxiliary poles in the cylindrical linear motor according to the present embodiment.

FIG. 7 is a transverse cross-sectional diagram for illustrating another first design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5K includes the plural units of ring-shaped stator-core salient poles 51K, and the two units of ring-shaped auxiliary poles 53K. The stator-core salient poles 51K are of a shape where the stator-core salient poles 51K are divided into a substantial T-character shape directly above the stator windings 7. The stator core 5K is configured such that the stator-core salient poles 51K are multi-layered alternately, and such that the not-illustrated auxiliary poles are multi-layered on both sides of this resultant multi-layered element. These configurations allow implementation of the magnetic circuit on the side of the stator 2.

The three units of stator windings 7 are deployed inside three units of slots. These slots are formed by the stator-core salient poles 51K which are adjacent to each other. Similarly to FIG. 1, the one unit of stator-core salient poles 51K includes the three units of stator-core small poles which are positioned at a portion situated on the inner-circumference side and opposed to the slider 3.

Incidentally, in FIG. 7, the case of the three units of stator windings is illustrated for simplicity of explanation. However, in the case where, as illustrated in FIG. 1, the three units of stator windings are provided in each phase of the U, V, and W phase, i.e., the nine units of stator windings are provided in total, the stator core 5K includes the eight units of ring-shaped stator-core salient poles 51K, and the two units of ring-shaped auxiliary poles.

In this way, the stator-core salient poles 51K are divided in the radial direction directly above the stator windings 7. This manner of division allows the division planes to be configured perpendicularly to the flow of the magnetic flux inside the stator core 5K, thereby making it possible to lower an influence which prevents the flow of the magnetic flux.

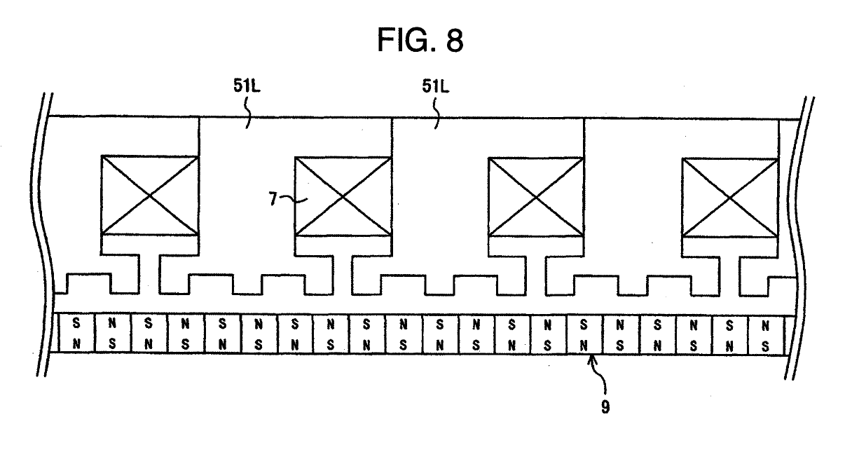

Next, referring to FIG. 8, the explanation will be given below regarding another second design configuration of the stator-core yokes, the stator-core salient poles, and the auxiliary poles in the cylindrical linear motor according to the present embodiment.

FIG. 8 is a transverse cross-sectional diagram for illustrating another second design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5L includes the plural units of ring-shaped stator-core salient poles 51L, and the two units of ring-shaped auxiliary poles 53L1 and 53L2. The stator-core salient poles 51L are of a shape where the stator-core salient poles 51L are divided into a substantial L-character shape at the end portion portions of the stator windings 7. The stator core 5L is configured such that the stator-core salient poles 51L are multi-layered alternately, and such that the not-illustrated auxiliary poles are multi-layered on both sides of this resultant multi-layered element. These configurations allow implementation of the magnetic circuit on the side of the stator 2.

The three units of stator windings 7 are deployed inside three units of slots. Each of the slots is formed by the stator-core salient poles 51L which are adjacent to each other. Similarly to FIG. 1, the one unit of stator-core salient poles 51L includes the three units of stator-core small poles which are positioned at a portion situated on the inner-circumference side and opposed to the slider 3.

Incidentally, in FIG. 8, the case of the three units of stator windings is illustrated for simplicity of explanation. However, in the case where, as illustrated in FIG. 1, the three units of stator windings are provided in each phase of the U, V, and W phase, i.e., the nine units of stator windings are provided in total, the stator core 5L includes the eight units of ring-shaped stator-core salient poles 51L, and the two units of ring-shaped auxiliary poles 53L1 and 53L2.

In this way, the stator-core salient poles 51L are divided into the substantial L-character shape at the end portion portions of the stator windings 7. This manner of division facilitates the positioning and suspension of the stator windings 7 with respect to the stator core 5L. Also, this manner of division facilitates, for example, the complete filling of the clearance between the stator core 5L and the stator windings 7 with an adhesive agent for fixing the stator core 5L and the stator windings 7, thereby allowing implementation of the configuration having an excellent heat-liberation property.

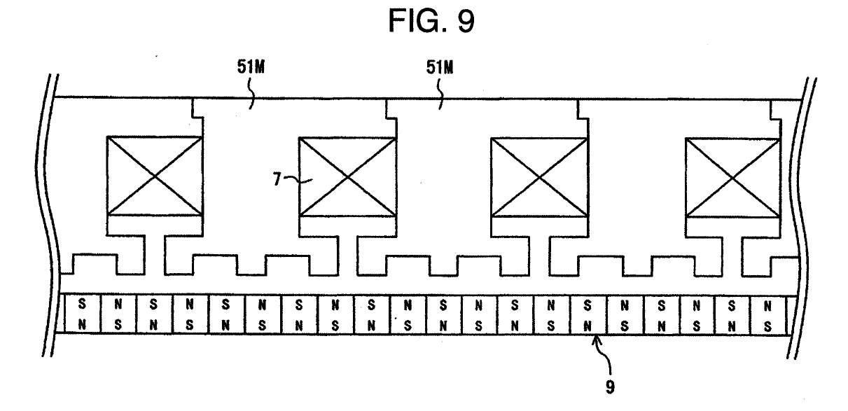

Next, referring to FIG. 9, the explanation will be given below regarding another third design configuration of the stator-core yokes, the stator-core salient poles, and the auxiliary poles in the cylindrical linear motor according to the present embodiment.

FIG. 9 is a transverse cross-sectional diagram for illustrating another third design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5M includes the plural units of ring-shaped stator-core salient poles 51M, and the two units of ring-shaped auxiliary poles 53M1 and 53M2. The stator-core salient poles 51M are of a shape where the stator-core salient poles 51M are divided into a substantial L-character shape at the end portion portions of the stator windings 7. Moreover, an interdigitation is provided on each of the division planes at the end portion portions of the stator windings 7. The stator core 5M is configured such that the stator-core salient poles 51M are multi-layered alternately, and such that the not-illustrated auxiliary poles are multi-layered on both sides of this resultant multi-layered element. These configurations allow implementation of the magnetic circuit on the side of the stator 2.

The three units of stator windings 7 are deployed inside three units of slots. These slots are formed by the stator-core salient poles 51M which are adjacent to each other, or the stator-core salient poles 51M and the auxiliary poles 53M1 and 53M2. Similarly to FIG. 1, the one unit of stator-core salient poles 51M includes the three units of stator-core small poles which are positioned at a portion situated on the inner-circumference side and opposed to the slider 3.

Incidentally, in FIG. 9, the case of the three units of stator windings is illustrated for simplicity of explanation. However, in the case where, as illustrated in FIG. 1, the three units of stator windings are provided in each phase of the U, V, and W phase, i.e., the nine units of stator windings are provided in total, the stator core 5M includes the eight units of ring-shaped stator-core salient poles 51M, and the two units of ring-shaped auxiliary poles 53M1 and 53M2.

In this way, the stator-core salient poles 51M are divided into the substantial L-character shape at the end portion portions of the stator windings 7. This manner of division facilitates the positioning and suspension of the stator windings 7 with respect to the stator core 5M. Also, this manner of division facilitates, for example, the complete filling of the clearance between the stator core 5M and the stator windings 7 with an adhesive agent for fixing the stator core 5M and the stator windings 7, thereby allowing implementation of the configuration having an excellent heat-liberation property. Furthermore, the interdigitation is provided on each of the division planes, which allows implementation of an enhancement in the coaxial degree in the axial direction.

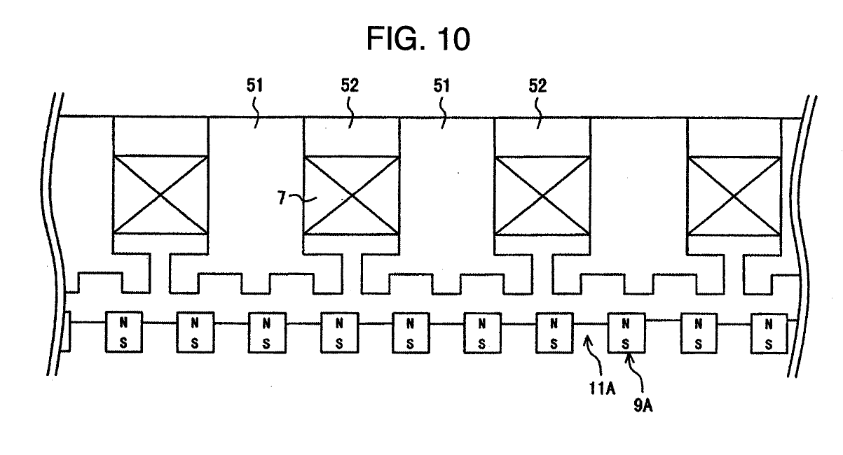

Next, referring to FIG. 10, the explanation will be given below regarding another design configuration of the permanent magnets in the cylindrical linear motor according to the present embodiment.

FIG. 10 is a transverse cross-sectional diagram for illustrating another design configuration of the permanent magnets in the cylindrical linear motor according to the first embodiment of the present invention. Incidentally, the same reference numerals as the ones in FIG. 1 denote the same configuration components.

In the illustrated embodiment, the design configuration of the stator core 5 is basically the same as the one illustrated in FIG. 1. Incidentally, in FIG. 10, the case of the three units of stator windings is illustrated for simplicity of explanation. However, in the case where, as illustrated in FIG. 1, the three units of stator windings are provided in each phase of the U, V, and W phase, i.e., the nine units of stator windings are provided in total, the stator core 5 includes the eight units of ring-shaped stator-core salient poles 51, and the two units of ring-shaped auxiliary poles 53.

The permanent magnets 9A are deployed along the outer-circumference portion of the slider core 11A with a predetermined spacing placed therebetween, i.e., with the equal spacing set thereto mutually. The polarities of the permanent magnets 9A are all the same. Meanwhile, a magnetic material is used as the material for the slider core 11A. The permanent magnets 9A are embedded into the slider core 11A which is composed of the magnetic material. Otherwise, the spacing between the respective permanent magnets 9A can be filled with the magnetic material. The portion of the magnetic material between the respective permanent magnets 9A functions as a virtual S pole.

This design configuration allows the number of the to-be-used permanent magnets to be reduced down to its one-half, thereby making it possible to reduce the cost.

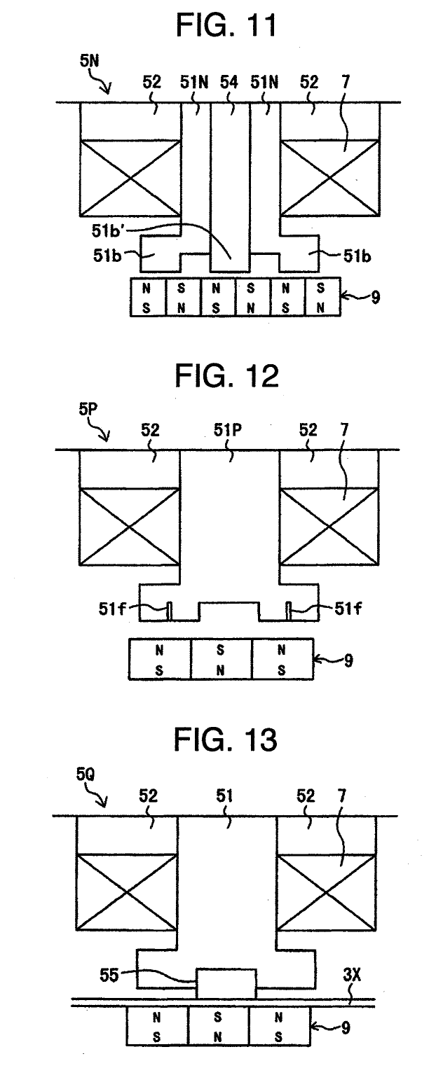

Next, referring to FIG. 11, the explanation will be given below regarding another fourth design configuration of the stator-core yokes and the stator-core salient poles in the cylindrical linear motor according to the present embodiment.

FIG. 11 is a transverse cross-sectional diagram for illustrating another fourth design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5N includes ring-shaped stator-core yokes 52 and the ring-shaped stator-core salient poles 51N.

A ring 54, which is composed of a magnetic material similar to that of the stator-core yokes 52, is inserted into the stator-core salient poles 51N. As is the case with the stator-core small poles 51b formed in the stator-core salient poles 51N, a stator-core small pole 51b′ can be formed at the end portion of the ring 54 on the inner-circumference side.

This design configuration makes it possible to reduce the machining number which is needed for machining the stator-core small pole slits 51c illustrated in FIG. 1.

Next, referring to FIG. 12, the explanation will be given below regarding another fifth design configuration of the stator-core yokes and the stator-core salient poles in the cylindrical linear motor according to the present embodiment.

FIG. 12 is a transverse cross-sectional diagram for illustrating another fifth design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5P includes the ring-shaped stator cores 52 and the ring-shaped stator-core salient poles 51P. Two units of stator-core small poles are formed at the inner-circumference-side end portions of each stator-core salient pole 51P.

Slits 51f are formed in the stator-core small poles at the inner-circumference-side end portions of each stator-core salient pole 51P.

This design configuration facilitates the division of the stator-core small poles.

Next, referring to FIG. 13, the explanation will be given below regarding another sixth design configuration of the stator-core yokes and the stator-core salient poles in the cylindrical linear motor according to the present embodiment.

FIG. 13 is a transverse cross-sectional diagram for illustrating another sixth design configuration of the stator-core yokes and the stator-core salient poles in the cylindrical linear motor according to the first embodiment of the present invention. Incidentally, the same reference numerals as the ones in FIG. 1 denote the same configuration components.

In the illustrated embodiment, the stator core 5Q includes the ring-shaped stator cores 52 and the ring-shaped stator-core salient poles 51Q. Two units of stator-core small poles are formed at the inner-circumference-side end portions of each stator-core salient pole 51Q.

A ring-shaped sliding bearing 55 composed of a non-magnetic material is set up in a slit portion between the two units of stator-core small poles of each stator-core salient pole 51Q. The sliding bearing 55 is slidably movable in such a manner that a thin-walled pipe 3X set up in the outer-circumference portion of the permanent magnets of the slider is utilized as its slidable-movement surface.

This design configuration increases variations in the support structure by the bearing.

As having been explained so far, according to the present embodiment, it becomes possible to acquire the high-damping and high-thrust cylindrical linear motor.

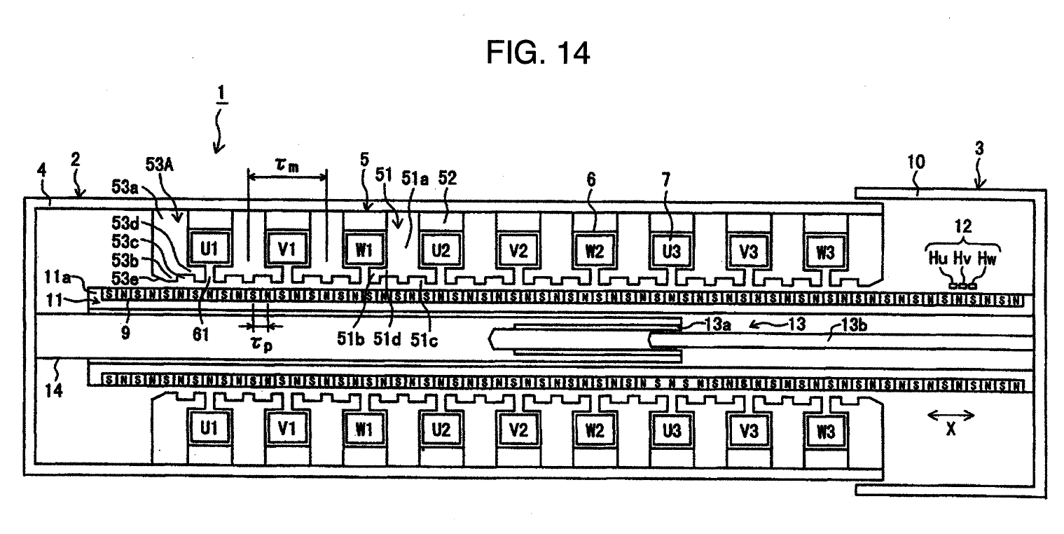

Next, referring to FIG. 14, the explanation will be given below concerning the entire configuration of a cylindrical linear motor according to a second embodiment of the present invention.

FIG. 14 is a transverse cross-sectional diagram for illustrating the configuration of the cylindrical linear motor according to the second embodiment of the present invention. Incidentally, the same reference numerals as the ones in FIG. 1 denote the same configuration components.

In the present embodiment, design configuration of auxiliary poles 53A differs from the one illustrated in FIG. 1. Namely, in addition to the auxiliary-pole small poles 53b which configure the magnetic path of the permanent magnets 9, and the auxiliary-pole small pole slits 53c which block the magnetic flux of the adjacent permanent magnets, each of the auxiliary poles 53A further includes a notch portion 53e of the auxiliary pole. This notch portion 53e is provided on the opposite sides to the sides on which the auxiliary poles 53A are in contact with the stator-core yokes 52, i.e., the portions positioned on both-ends sides of the stator core 5, and the sides opposed to the slider 3.

In the configuration illustrated in FIG. 1, considering from the magnetic point-of-view, there is a possibility that the magnetic circuit of the stator core 5 and the slider 3 causes cogging to occur. Here, this cogging has a period which is equal to τp, i.e., the pitch of the permanent magnets 9, or an integral sub-multiple of the pitch τp.

In order to address this possibility, the notch portions 53e of the auxiliary poles are provided. Namely, the auxiliary-pole notch portions 53e make it possible to relax a variation in the magnetic energy between the stator 2 and the slider 3. As a result, it becomes possible to relax the occurrence of the cogging torque. By optimizing the axial-direction length and inclination of the auxiliary-pole notch portions 53e positioned at axial-direction both ends of the stator core 5, it becomes possible to minimize the phenomena such as the cogging torque and thrust pulsation.

Incidentally, the configurations illustrated in FIG. 7 to FIG. 13 are also applicable to the present embodiment.

As having been explained so far, according to the present embodiment, it becomes possible to acquire the high-damping and high-thrust cylindrical linear motor.

Also, it becomes possible to reduce the cogging.

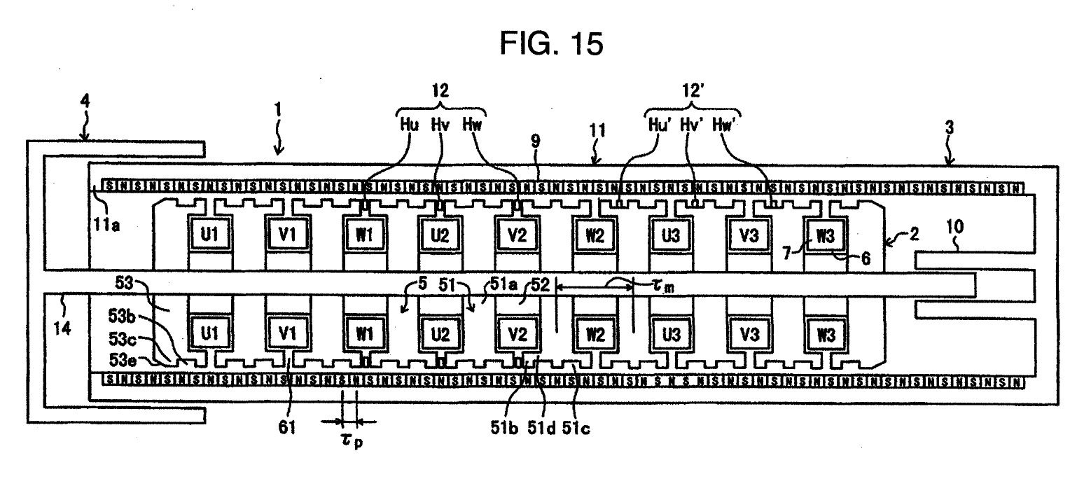

Next, referring to FIG. 15 to FIG. 20, the explanation will be given below concerning the entire configuration of a cylindrical linear motor according to a third embodiment of the present invention.

First, referring to FIG. 15, the explanation will be given below concerning the entire configuration of the cylindrical linear motor according to the third embodiment of the present invention.

FIG. 15 is a transverse cross-sectional diagram for illustrating the configuration of the cylindrical linear motor according to the third embodiment of the present invention. Incidentally, the same reference numerals as the ones in FIG. 1 denote the same configuration components.

In the present embodiment, the main feature lies in the following point: The deployment of the stator 2 and the slider 3 in the inner and outer circumferences is made reverse with respect to the deployment illustrated in FIG. 1.

The principle of the electromagnetic thrust, which exerts between the stator 2 and the slider 3, remains unchanged in principle. The feature, however, lies in the following points:

First, the position of the clearance portion between the stator 2 and the slider 3, i.e., the thrust-generation plane, displaces in the radial direction. This displacement increases the area of this clearance portion. Here, in general, the maximum value of the per-unit-area thrust generated by electromagnetic phenomena is substantially constant. As a result, increasing this area allows implementation of an increase in the thrust.

Second, the central position of the stator windings 7 comes to be situated on an inner-diameter side as compared with the case illustrated in FIG. 1. Consequently, it becomes possible to shorten the length of the per-one-circumference stator windings. This makes it possible to increase Ke, i.e., the power-generation constant, and further to decrease the resistance R. As a result, it becomes possible to acquire the high damping (i.e., Ke²/R).

Next, in the present embodiment, the position of the pole-position sensor differs from the one illustrated in FIG. 1. Here, the explanation will be given below regarding two types of positions of the pole-position sensor.

As the first deployment, the pole-position sensor 12, which is configured from the three units of hole elements Hu, Hv, and Hw, is deployed in the slits 61 each of which exists between the adjacent stator-core salient poles 51. Each of the slits 61 between the adjacent stator-core salient poles 51 is equal to the spacing between the adjacent stator-core salient poles 51 in terms of the electric angle. By taking advantage of this condition, and deploying the hole elements Hu, Hv, and Hw, i.e., the each-phase pole-position sensor 12, into the continuous slits 61, it becomes possible to detect the magnetic-density distribution of the permanent magnets 9 between the stator 2 and the slider 3. In the illustrated configuration where the pole number is large, this magnetic-density distribution becomes the substantially sinusoidal-wave-shaped distribution. Consequently, executing the simple transformation allows the detection of the relative position between the slider 3 and the stator 2.

As the second deployment, the pole-position sensor 12 configured from the hole elements Hu, Hv, and Hw is deployed on the inner sides of the stator-core small pole slits 51c. This deployment also allows the detection of the relative position between the slider 3 and the stator 2.

Incidentally, in the present embodiment, the stroke sensor 13 illustrated in FIG. 1 is omitted. Namely, the pole-position sensor 12 is used for detecting the stroke as well.

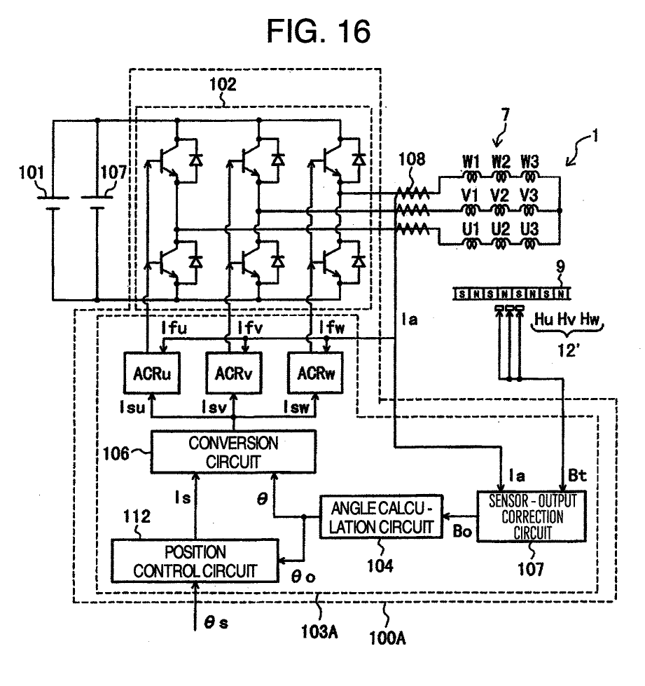

Next, referring to FIG. 16, the explanation will be given below concerning the configuration of a cylindrical linear motor device which uses the cylindrical linear motor according to the present embodiment.

FIG. 16 is a block diagram for illustrating the configuration of the cylindrical linear motor device which uses the cylindrical linear motor according to the third embodiment of the present invention. Incidentally, the same reference numerals as the ones in FIG. 15 denote the same configuration components.

The cylindrical linear motor device according to the present embodiment includes the cylindrical linear motor 1, the DC power-supply 101 which configures the driving power-supply for the cylindrical linear motor 1, and a control device 100A for controlling the driving for the cylindrical linear motor 1 by controlling the power to be supplied to the cylindrical linear motor 1.

The cylindrical linear motor 1 is configured as was illustrated in FIG. 15. Here, as was explained in FIG. 15, there exist the example where the pole-position sensor 12 is deployed inside the slits 61, and the example where the pole-position sensor 12 is deployed inside the stator-core small pole slits 51c. Here, with respect to the case where the pole-position sensor 12 is deployed inside the stator-core small pole slits 51c, the explanation will be given below regarding the output of the pole-position sensor 12, an influence on the angle by the magnetic field, a method for correcting this influence, and the configuration and operation of a current-passing control into the cylindrical linear motor 1 on the basis of the pole-position information.

In FIG. 16, the DC power-supply 101 is a device capable of supplying the DC power. The control device 100A is an inverter device for converting the DC power supplied from the DC power-supply 101 into a predetermined AC power, and supplying the AC power to the stator windings 7.

The control device 100A includes the power-system inverter circuit 102 (i.e., power conversion circuit) which is electrically connected to between the DC power-supply 101 and the stator windings 7, and a control circuit 103A for controlling the operation of the inverter circuit 102.

The inverter circuit 102 is a bridge circuit configured from switching-use semiconductor elements (e.g., MOS-FETs: Metal-Oxide-Semiconductor Field-Effect Transistors, IGBTs: Insulated-Gate Bipolar Transistors). The bridge circuit is configured such that in-series circuits, which are referred to as “arms”, are electrically connected to each other in parallel by the amount of the phase number (i.e., three, since the present embodiment is of the three phases) of the cylindrical linear motor 1. Each arm is configured such that the switching-use semiconductor element on the upper side and the switching-use semiconductor element on the lower side are electrically connected to each other in series. The higher-potential-side circuit terminal of each arm is electrically connected to the positive-pole side of the DC power-supply 101, and the lower-potential-side circuit terminal of each arm is electrically connected to the negative-pole side of the DC power-supply 101. The midpoint (i.e., connection point of the switching-use semiconductor element on the upper side and the switching-use semiconductor element on the lower side) of each arm is electrically connected to the corresponding-phase windings of the stator windings 7.

A smoothing capacitor 107 is electrically connected to between the DC power-supply 101 and the inverter circuit 102. A current sensor 108 is provided between the inverter circuit 102 and the stator windings 7. The current sensor 108, which is configured from appliances such as current transformer, is used for detecting the DC current which flows in each phase.

The control circuit 103A controls operation (i.e., ON/OFF) of the switching-use semiconductor elements of the inverter circuit 102 on the basis of input information. In addition to the configuration illustrated in FIG. 5, the control circuit 103A includes a sensor-output correction circuit 107.

The input information into the control circuit 103A are the requested thrust (current command signal Is) for the cylindrical linear motor 1, and the pole position θ of the slider 3 of the cylindrical linear motor 1. The requested thrust (current command signal Is) is command information which is outputted from a higher-order position control circuit in accordance with the request amount requested for the to-be-driven element. The pole position θ is detection information which is acquired from the output of the pole-position sensor 12′. Here, as illustrated in FIG. 16, the current command signal Is is given from the higher-order position control circuit 112. The higher-order position control circuit 112 calculates the current command signal Is from the position information θo (which is identical to θ, and is substituted for the stroke signal) from the pole-position sensor 12′ and the position command θs.

The output signal Bt is outputted from the pole-position sensor 12′ configured from the three units of hole elements Hu, Hv, and Hw. In accompaniment with an output signal Ia outputted from the current sensor 108 (i.e., detection signal for the three-phase currents supplied to the stator windings 7), the output signal Bt is inputted into the sensor-output correction circuit 107 by an A/D converter (whose illustration is omitted). Based on sensor-output information acquired from the output signal Ia of the current sensor 108, the sensor-output correction circuit 107 creates sensor-output correction information Ba. Then, based on this sensor-output correction information Ba, the sensor-output correction circuit 107 corrects the sensor-output information acquired from the output signal Bt of the pole-position sensor 12′. Moreover, the sensor-output correction circuit 107 creates corrected position sensor-output information Bo, then transmitting this information Bo to the control circuit. Additionally, the explanation will be given later regarding a concrete correction method for the sensor-output information in the sensor-output correction circuit 107.

Here, the output signal Ia outputted from the current sensor 108 includes a high-frequency component caused by the PWM (: Pulse-Width Modulation). Enhancing the detection accuracy for the pole position θ of the slider 3 requires that this high-frequency component be eliminated. Accordingly, in the present embodiment, this high-frequency component is eliminated by providing a filter circuit (whose illustration is omitted) on the input side of the sensor-output correction circuit 107.

The corrected position sensor-output information Bo is inputted into the angle calculation circuit 104 from the sensor-output correction circuit 107. The angle calculation circuit 104 calculates and outputs the pole-position information θ of the slider 3 from the corrected position sensor-output information Bo.

The pole-position information θ outputted from the angle calculation circuit 104 is inputted into the conversion circuit 106. In addition to the pole-position information θ, the requested thrust (current command signal Is) outputted from the higher-order position control circuit 112 is inputted into the conversion circuit 106. Based on the pole-position information θ outputted from the angle calculation circuit 104, the conversion circuit 106 converts a current command value acquired from the current command signal Is into each-phase current command values Isu, Isv, and Isw in accordance with a sinusoidal-wave output in the same phase as the each-phase induced voltages of the stator windings 7, or the sinusoidal-wave output which has undergone a phase shift.

The each-phase current command values Isu, Isv, and Isw outputted from the conversion circuit 106 are inputted into the corresponding-phase current control systems (ACR) 105. In addition to the each-phase current command values, the output signals Ifu, Ifv, and Ifw outputted from the corresponding-phase current sensor 108 are inputted into the each-phase current control systems (ACR) 105. Based on each-phase current values obtained from the output signals Ifu, Ifv, and Ifw outputted from the corresponding-phase current sensor 108, and the corresponding-phase current command values Isu, Isv, and Isw, the each-phase current control systems (ACR) 105 output driving signals for driving the switching-use semiconductor elements of the corresponding-phase arms.

The driving signals outputted from the each-phase current control systems (ACR) 105 are inputted into the control terminals of the switching-use semiconductor elements which configure the corresponding-phase arms. This input of the driving signals causes each switching-use semiconductor element to perform its ON/OFF operation. As a consequence, the DC power supplied from the DC power-supply 101 is converted into the AC power, then being supplied to the corresponding-phase windings of the stator windings 7.

In the inverter device according to the present embodiment, the currents flowing through the stator windings 7 (i.e., the phase currents flowing through the each-phase windings) are always created in such a manner that a resultant composite vector of armature magnetomotive forces generated by the currents flowing through the stator windings 7 becomes perpendicular with respect to the direction of the magnetic flux or magnetic field generated by the permanent magnets 9, or in such a manner that the resultant composite vector of the armature magnetomotive forces generated by the currents flowing through the stator windings 7 undergoes a phase shift (namely, the resultant composite vector advances by 90° or more (in terms of the electric angle) with respect to the direction of the magnetic flux or magnetic field generated by the permanent magnets 9). On account of this feature, in the permanent-magnet type rotating electrical device of the present embodiment, the use of the non-commutator (i.e., brushless) cylindrical linear motor 1 makes it possible to acquire the characteristics which are equivalent to the ones of the DC linear motor. Incidentally, the above-described control, namely, the currents flowing through the stator windings 7 (i.e., the phase currents flowing through the each-phase windings) are always created in such a manner that the resultant composite vector of the armature magnetomotive forces generated by the currents flowing through the stator windings 7 advances by 90° or more (in terms of the electric angle) with respect to the direction of the magnetic flux or magnetic field generated by the permanent magnets 9, is referred to as “field-weakening control”.

The inverter device according to the present embodiment is used when the high-speed driving for the cylindrical linear motor 1 is implemented using a limited DC voltage.

Accordingly, in the cylindrical linear motor device according to the present embodiment, the currents flowing through the stator windings 7 (i.e., the phase currents flowing through the each-phase windings) are controlled based on the pole position of the slider 3 in such a manner that the resultant composite vector of the armature magnetomotive forces generated by the currents flowing through the stator windings 7 becomes perpendicular with respect to the direction of the magnetic flux or magnetic field generated by the permanent magnets 9. The execution of this control permits the maximum thrust to be outputted continuously from the cylindrical linear motor 1. When the field-weakening control is necessary, it is advisable enough to control the currents flowing through the stator windings 7 (i.e., the phase currents flowing through the each-phase windings) based on the pole position of the slider 3 in such a manner that the resultant composite vector of the armature magnetomotive forces generated by the currents flowing through the stator windings 7 advances by 90° or more (in terms of the electric angle) with respect to the direction of the magnetic flux or magnetic field generated by the permanent magnets 9.

Also, in the cylindrical linear motor 1 according to the present embodiment, the waveforms of the voltages induced in the each-phase windings of the stator windings 7 become the sinusoidal waveform. This is attributed to a phenomenon that the magnetic-density distribution in the clearance between the stator 2 and the slider 3 naturally becomes the sinusoidal-wave-shaped distribution by the fact that the pole number of the permanent magnets 9 in the cylindrical linear motor 1 illustrated in FIG. 1 is made larger. In the inverter device according to the present embodiment, the sinusoidal-wave currents in accordance with the pole position of the slider 3 are passed through the each-phase windings of the stator windings 7 by 180° (in terms of the electric angle) with respect to the above-described sinusoidal-wave induced voltages. Consequently, in the cylindrical linear motor device according to the present embodiment, the variation in the outputted thrust of the cylindrical linear motor 1 can be suppressed down to a small value.

Also, in the rotating electrical device according to the present embodiment, the hole elements or hole ICs, which are magnetism-sensing elements, are employed as the pole-position sensor 12′. This feature allows the space to be reduced significantly as compared with the case where such sensors as the stroke sensor 13 are employed. As a result, taking advantage of this reduced space for the magnetic circuit and windings space makes it possible to implement the high-damping cylindrical linear motor.

Furthermore, it becomes possible to perform the pole-position detection with the simple configuration and at a low cost.

Also, in the rotating electrical device according to the present embodiment, the hole elements are mounted on the stator core 5. This feature makes it unnecessary to perform a phase adjustment operation between the induced voltages and the outputs from the hole elements or hole ICs, thereby making it possible to facilitate the mounting operation for the pole-position sensor 12′.

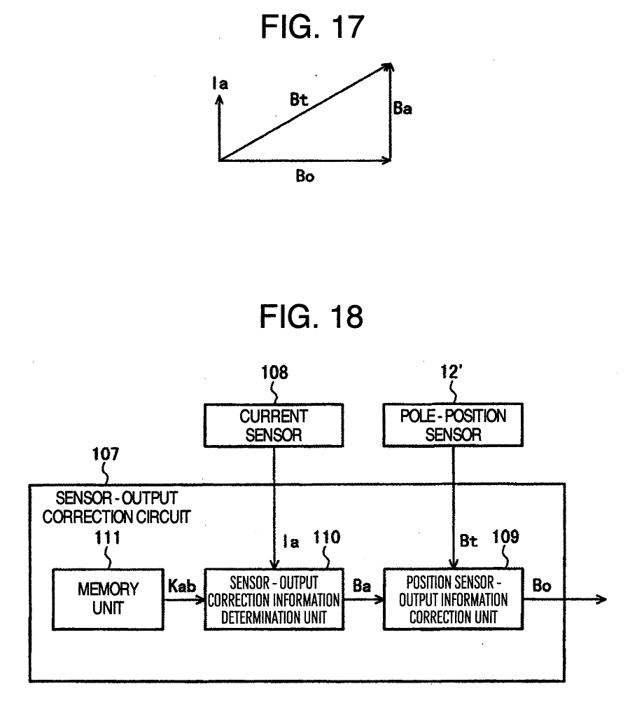

Here, referring to FIG. 17, the explanation will be given below regarding the correction principle of the output information of the pole-position sensor 12′ in the cylindrical linear motor device which uses the cylindrical linear motor according to the present embodiment.

FIG. 17 is an explanatory diagram for explaining the correction principle of the output information of the pole-position sensor in the cylindrical linear motor device which uses the cylindrical linear motor according to the third embodiment of the present invention.

In the present embodiment, the pole-position sensor 12′ is deployed within the magnetic field generated by the stator windings 7. This feature makes it unnecessary to set up a special pole-position sensor such as the stroke sensor 13 at the axis end of the slider 3. This feature also makes it possible to accomplish the small-sized implementation of the rotating electrical device, and to omit operations such as the pole-position alignment of the pole-position sensor.

In order to implement this correction, in the present embodiment, an amount of the influence by the magnetic field due to the driving current is excluded from the output information (i.e., position information) of the pole-position sensor which has undergone the influence by the magnetic field due to the driving current. This exclusion is performed in accordance with the output information (i.e., current information) of the current sensor. Moreover, the pole position of the slider 3 is detected from the position information from which the amount of the influence by the magnetic field due to the driving current has been excluded. This method, in the present embodiment, allows implementation of a reduction in the error involved in the output information (i.e., position information) of the pole-position sensor, thereby making it possible to reduce the thrust pulsation of the cylindrical linear motor 1.

Here, the influence by the magnetic field due to the driving current can be determined from the relationship of the vectors illustrated in FIG. 17. In FIG. 17, Bt denotes the output information (i.e., position information) of the pole-position sensor 12′ at the time of the load, and Ia denotes the output information (i.e., current information) of the current sensor 108. As is shown from the relationship of the vectors illustrated in FIG. 17, the amount Ba of the influence by the magnetic field due to the driving current, which is involved in the position information Bt, is a component whose direction is the same as the direction of the current information Ia, and whose magnitude is substantially proportional to the current information Ia. Accordingly, the amount Ba can be determined in advance from the current information Ia on the basis of a measurement or calculation concerned. This determination makes it possible to determine the sensor-output information Bo which has not undergone the influence by the magnetic field due to the driving current. The sensor-output information Bo which has not undergone the influence by the magnetic field due to the driving current is equivalent to the output information of the pole-position sensor 12′ at the time of no load when the driving current is not flown. On account of this, in the present embodiment, the amount Ba of the influence by the magnetic field due to the driving current is determined in correspondence with the current information Ia. Furthermore, the amount Ba of the influence by the magnetic field due to the driving current is eliminated from the position information Bt, thereby outputting the corrected position sensor-output information Bo.

Next, referring to FIG. 18, the explanation will be given below concerning the configuration of the sensor-output correction circuit 107 used in the cylindrical linear motor device which uses the cylindrical linear motor according to the present embodiment.

FIG. 18 is a block diagram for illustrating the configuration of the sensor-output correction circuit used in the cylindrical linear motor device which uses the cylindrical linear motor according to the third embodiment of the present invention.

The sensor-output correction circuit 107 is configured using a microcomputer. The microcomputer configuring the sensor-output correction circuit 107 is allowed to be provided separately from a microcomputer configuring the control circuit for the inverter circuit. Also, the sensor-output correction circuit 107 is allowed to be configured using the microcomputer configuring the control circuit for the inverter circuit. The latter case is preferable from the viewpoint of cost reduction.

The output signal (i.e., analog signal) Bt outputted from the pole-position sensor 12′ and the output signal (i.e., analog signal) Ia outputted from the current sensor 108 are inputted into the sensor-output correction circuit 107. The output signal from the pole-position sensor 12′ and the output signal from the current sensor 108 are converted into digital signals by an A/D converter (whose illustration is omitted). This conversion allows acquisition of the sensor-output information (i.e., waveform data) Bt of the pole-position sensor 12′ and the sensor-output information (i.e., waveform data) Ia of the current sensor 108.

The sensor-output information Bt of the pole-position sensor 12′ and the sensor-output information Ia of the current sensor 108 are inputted into a position sensor-output information correction unit 109 and a sensor-output correction information determination unit 110, respectively. Also, sensor-output correction basic information Kab, which is outputted from a memory unit 111, is inputted into the sensor-output correction information determination unit 110. The memory unit 111 stores therein, as the sensor-output correction basic information Kab, a map (i.e., data table) for indicating the relationship between the sensor-output information Ia (i.e., the driving current) and the sensor-output correction information Ba (i.e., the amount of the influence by the magnetic field due to the driving current) in a 1-cycle amount of electric angle, which is determined in advance from the relationship of the vectors illustrated in FIG. 17 on the basis of the measurement or calculation concerned.

Using the sensor-output correction basic information Kab, the sensor-output correction information determination unit 110 determines the sensor-output correction information Ba corresponding to the sensor-output information Ia of the current sensor 108, then outputting the sensor-output correction information Ba to the position sensor-output information correction unit 109. In a non-linear case, making reference to the sensor-output information Ia makes it possible to determine the information Ba.

In the above-described correction, a simpler correction control is executable by decomposing a position error into the respective frequency components, and executing the control on each frequency basis.

The position sensor-output information correction unit 109 calculates a difference between the sensor-output information Bt of the pole-position sensor 12′ and the sensor-output correction information Ba. This calculation permits the sensor-output information Bt of the pole-position sensor 12′ to be corrected based on the sensor-output correction information Ba. The difference value between the sensor-output information Bt of the pole-position sensor 121 and the sensor-output correction information Ba is outputted to the angle calculation circuit 104 as the corrected position sensor-output information Bo.

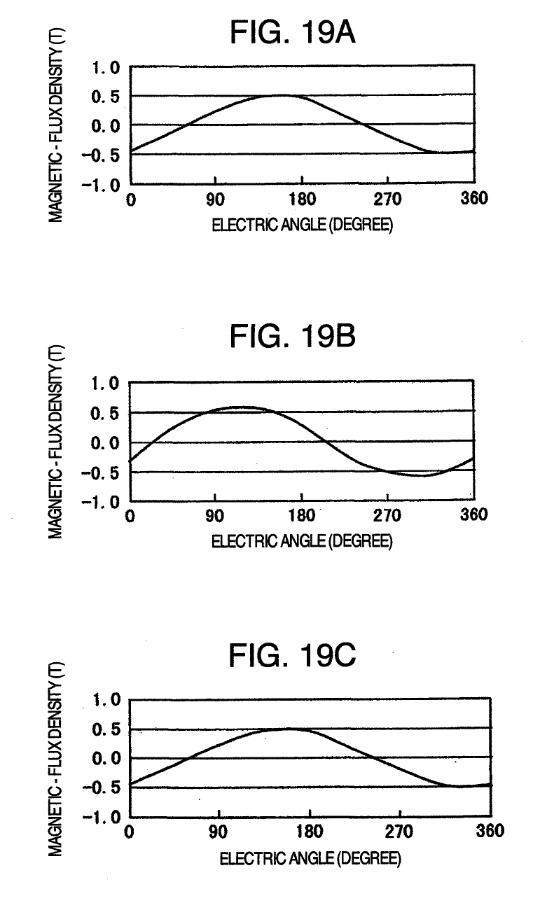

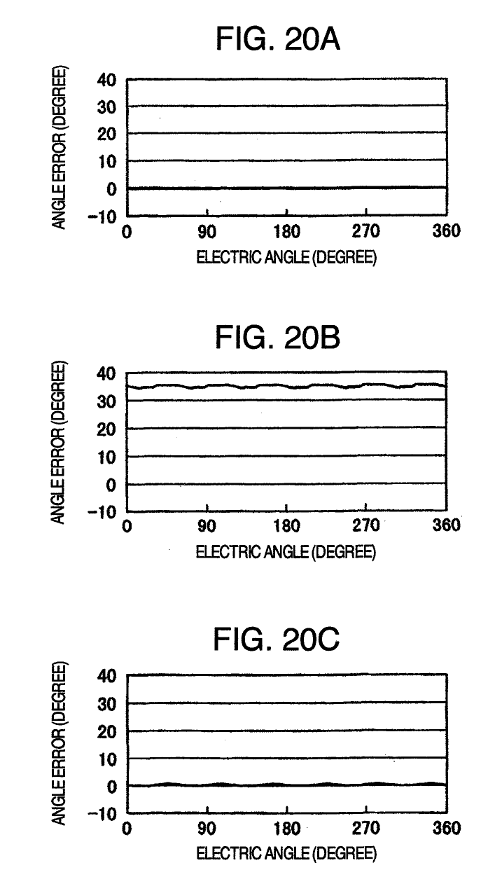

Next, referring to FIG. 19A to FIG. 19C and FIG. 20A to FIG. 20C, the explanation will be given below regarding the operation and correction result of the sensor-output correction circuit 107 used in the cylindrical linear motor device which uses the cylindrical linear motor according to the present embodiment.

FIG. 19A to FIG. 19C and FIG. 20A to FIG. 20C are explanatory diagrams for explaining the operation and correction result of the sensor-output correction circuit 107 used in the cylindrical linear motor device which uses the cylindrical linear motor according to the third embodiment of the present invention.

In FIG. 19A to FIG. 19C, the transverse axis denotes the electric angle (degree), and the longitudinal axis denotes the magnetic-flux density (T). FIG. 19A, FIG. 19B, and FIG. 19C indicate the relationship of the magnetic-flux density (T) relative to a 1-cycle amount of electric angle (degree).

FIG. 19A indicates an output waveform of the U-phase-dedicated Hu pole-position sensor 12′ in the case of the 0-% windings current. Namely, this waveform is equivalent to the output waveform of the pole-position sensor 12′ at the time of no load (i.e., the sensor-output information Bt at the time of no load).

FIG. 19B indicates an output waveform of the U-phase-dedicated Hu pole-position sensor 12′ in the case of the 100-% windings current. Namely, this waveform is equivalent to the output waveform of the pole-position sensor 12′ at the time of full load (i.e., the sensor-output information Bt at the time of full load).

FIG. 19C indicates an output waveform of the U-phase-dedicated Hu pole-position sensor 12′ in the case of the 100-% windings current. Namely, this waveform is equivalent to the after-being-corrected output waveform of the pole-position sensor 12′ at the time of full load (i.e., the corrected position sensor-output information Bo at the time of full load).

Incidentally, in FIG. 19A to FIG. 19C, the illustration is given to the U phase alone. With respect to the V and W phases, however, the V phase becomes a waveform whose phase is shifted by 120° from the U phase in terms of the electric angle, and the W phase becomes a waveform whose phase is shifted by 240° from the U phase in terms of the electric angle.

Here, the waveform of the sensor-output correction information Ba is omitted. As described earlier, however, the information Ba is determined from the sensor-output correction basic information Kab based on the sensor-output information Ia of the current sensor 108.

As is obvious from FIG. 19A to FIG. 19C, the corrected position sensor-output information Bo at the time of full load results from eliminating the amount of the sensor-output correction information Ba from the sensor-output information Bt at the time of full load. As a result, the waveform of the information Bo becomes substantially the same as the waveform of the sensor-output information Bt at the time of no load. This shows that the detection accuracy of the pole-position sensor 12′ can be enhanced.

In FIG. 20A to FIG. 20C, the transverse axis denotes the electric angle (degree), and the longitudinal axis denotes the angle error (degree). FIG. 20A, FIG. 20B, and FIG. 20C indicate the relationship of the angle error relative to the 1-cycle amount of electric angle (degree).

FIG. 20A, FIG. 20B, and FIG. 20C indicate waveforms of the angle error which are involved in the output waveform of the angle calculation circuit 104 when the each-phase waveforms in the three respective states illustrated in FIG. 19A, FIG. 19B, and FIG. 19C are employed as the input waveforms. The angle error is a difference between a real and accurate pole position of the slider 3 at the time when the driving current is supplied to the cylindrical linear motor 1, and the pole position of the slider 3 estimated by being calculated from the sensor-output information of the pole-position sensor 12′.

Here, FIG. 20A indicates the waveform of the angle error involved in the output waveform of the angle calculation circuit 104 in the case of the 0-% windings current (at the time of no load). FIG. 20B indicates the waveform of the angle error involved in the output waveform of the angle calculation circuit 104 in the case of the 100-% windings current (at the time of full load), and in the case where the sensor-output correction is absent. FIG. 20C indicates the waveform of the angle error involved in the output waveform of the angle calculation circuit 104 in the case of the 100-% windings current (at the time of full load), and in the case where the sensor-output correction is present (here, an average angle error relative to the current is corrected).

As is obvious from FIG. 20A to FIG. 20C, thanks to the execution of the sensor-output correction, the angle error involved in the output waveform of the angle calculation circuit 104 in the case of the 100-% windings current (at the time of full load) can be reduced tremendously as compared with the angle error involved in the output waveform of the angle calculation circuit 104 in the case of the 100-% windings current (at the time of full load), and in the case where the sensor-output correction is not executed. As a result, the angle error involved in the output waveform of the angle calculation circuit 104 in the case of the 100-% windings current (at the time of full load) can be made substantially identical to the angle error involved in the output waveform of the angle calculation circuit 104 in the case of the 0-% windings current (at the time of no load). This also shows that the detection accuracy of the pole-position sensor 12′ can be enhanced.

The above-described control allows the pole-position sensor 12′ to be installed inside the cylindrical linear motor 1, thereby making it possible to prevent such phenomena as the lowering in the damping and thrust caused by the deployment of the stroke sensor 13. In the above-described explanation, the example has been indicated where the pole-position sensor 12′ is deployed inside the stator-core small pole slits 51c. In the case where the pole-position sensor 12′ is deployed inside the slits 61, the direction of the pole-position sensor 12′ becomes parallel to the magnetic field by the stator windings 7, and thus the sensitivity becomes its minimum. Simultaneously, the direction of the pole-position sensor 12′ becomes perpendicular to the magnetic field by the permanent magnets 9, and thus the sensitivity becomes its maximum. As a consequence, the detection error caused by the stator-windings current becomes at least smaller than the detection error in the case where the pole-position sensor 12′ is deployed inside the stator-core small pole slits 51c. Otherwise, there is even a possibility that the angle correction with respect to the stator-windings current becomes unnecessary.

The above-described features, such as the deployment of the pole-position sensor 12′ and the correction control, make it possible to omit such devices as the stroke sensor 13. Also, since a special space where the pole-position sensor 12′ is to be deployed is unnecessary, this space can be used for increasing the thrust and damping. This feature makes it possible to provide the high-damping and high-thrust cylindrical linear motor. Also, it becomes possible to accomplish the small-sized implementation of the motor.

In the foregoing embodiments, the explanation has been given selecting, as the example, the pole-position sensor configured using the hole elements or hole ICs. As the pole-position sensor, however, other devices such as magneto-resistance effect elements are also available. In the case like this, the effects explained in the foregoing embodiments can also be accomplished.

Also, the control circuit for the cylindrical linear motor device illustrated in FIG. 15 includes none of the stroke sensor. Consequently, the control circuit for the cylindrical linear motor device illustrated in FIG. 16 and FIG. 18 is also applicable to the case where the cylindrical linear motor illustrated in FIG. 1 or FIG. 15 includes none of the stroke sensor, and where the pole-position sensor 12′ is deployed inside the stator-core small pole slits 51c.

Incidentally, the configurations illustrated in FIG. 7 to FIG. 13 are also applicable to the present embodiment.

As having been explained so far, according to the present embodiment, it becomes possible to acquire the high-damping and high-thrust cylindrical linear motor.

Also, it becomes possible to reduce the cogging.

Moreover, it becomes possible to accomplish the small-sized implementation of the motor.

Next, referring to FIG. 21, the explanation will be given below concerning the configuration of a railroad vehicle where the cylindrical linear motor according to each embodiment of the present invention is used as an electromagnetic suspension.

FIG. 21 is a configuration diagram of the railroad vehicle where the cylindrical linear motor according to each embodiment of the present invention is used as the electromagnetic suspension.

A railroad vehicle 200 is configured from a vehicle body 201 and a vehicle truck 202. The vehicle truck 202 is supported by a vehicle axis 203 equipped with wheels 204 via springs 205. The vehicle truck 202 supports the vehicle body 201 via springs 208. Also, the vehicle truck 202 supports the cylindrical linear motor 1 and a damper 209 via a vehicle-truck-side flange 211 fixed to the vehicle truck 202 and a vehicle-body-side flange 210 fixed to the vehicle body 201. The cylindrical linear motor 1 has the configuration illustrated in FIG. 1 or FIG. 15.

The vehicle body 201 includes an acceleration sensor 207 and a fluctuation control device 206. In accordance with a signal from the acceleration sensor 207, the fluctuation control device 206 issues a thrust command to the cylindrical linear motor 1 so that the acceleration is decreased, thereby generating the thrust for suppressing fluctuation. Here, the earlier-described control device for the cylindrical linear motor 1 is included in the fluctuation control device 206.

In this way, the fluctuation control device 206 issues the thrust command corresponding to the output from the acceleration sensor 207, then applying the thrust command to the control device for the cylindrical linear motor 1. This allows a current for causing the thrust to become its maximum to be passed through each phase while acquiring the position signal for the cylindrical linear motor 1, thereby making it possible to exhibit a desired fluctuation-preventing effect. As a result, it becomes possible to implement the vehicle body 201 with only a small transverse swinging.

Here, if the control device for the cylindrical linear motor 1 fails, the short-circuit current is flown by establishing the short-circuit of the three-phase terminals of the cylindrical linear motor 1. As a result, the loss consumed inside the cylindrical linear motor 1 allows acquisition of the high-damping characteristics, thereby making it possible to reduce the fluctuation.

When the railroad vehicle 200 is equipped with the damper 209, it becomes possible to acquire an effective fluctuation-suppressing effect by transmitting a damper damping-force switching signal from the fluctuation control device 206 to the damper 209. Here, the damper damping-force switching signal is a signal for switching the damper 209's damping force into a smaller value when the control is actively executed by the thrust of the cylindrical linear motor 1, and switching the damper 209's damping force into a larger value when the cylindrical linear motor 1 fails. Furthermore, in the present invention, the damping of the cylindrical linear motor 1 can be increased. Accordingly, if the function of the damper 209 which is exhibited at the time of the failure can be exhibited, the damper 209 can be omitted. This feature allows implementation of the railroad vehicle which is equipped with the electromagnetic suspension whose configuration is simple.

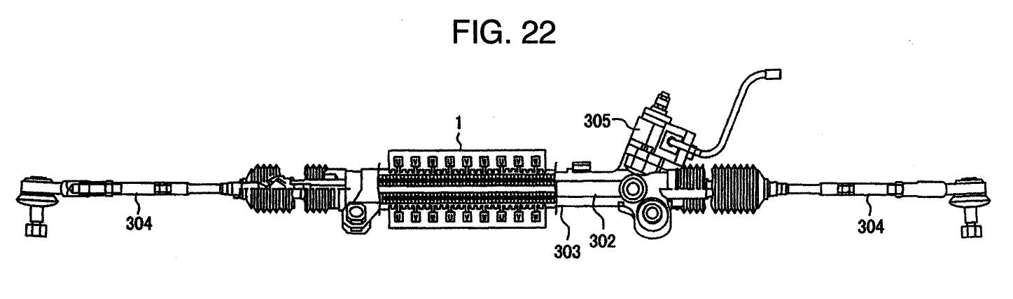

Next, referring to FIG. 22, the explanation will be given below regarding the configuration of a rack-&-pinion scheme motor-driven power steering device to which the cylindrical linear motor according to each embodiment of the present invention is applied.

FIG. 22 is a configuration diagram of the rack-&-pinion scheme motor-driven power steering device to which the cylindrical linear motor according to each embodiment of the present invention is applied. Incidentally, in FIG. 22, only the linear motor portion is illustrated in its cross-section.

The motor-driven power steering device illustrated in FIG. 22 is a motor-driven power steering device for transmitting the steering-assistance-purpose thrust from the cylindrical linear motor 1 to a rack axis 303 inside a rack housing 302, and transmitting this thrust to a tie-rod 304 so as to assist the steering of not-illustrated tires (front wheels, in general). The cylindrical linear motor 1 has the configuration illustrated in FIG. 1 or FIG. 15.

A pinion housing 305 is set up on the rack housing 302. A not-illustrated pinion gear is set up on the rack-gear side of the pinion housing 305. Also, a steering wheel is set up via a not-illustrated steering column.

When the steering wheel is rotationally operated for the steering, the pinion gear is rotated via the steering column. In this way, the steering torque is transmitted to the rack gear, thereby being converted into the movement of the rack axis 303. The linear motor 1 generates an assistance force at this time. The mechanism and control contents for generating the assistance force have been publicly known, and thus are omitted here.

The application of the linear motor according to each embodiment to the motor-driven power steering device allows acquisition of the following effects:

First, a sense of steering felt by a driver who operates the steering wheel can be enhanced. This is because the thrust from the linear motor 1 is directly applied to the rack axis 303 with no deceleration mechanism or rotation/translation mechanism intervening therebetween in a mechanism-dependent manner.

Second, a steering force applied by a driver who operates the steering wheel can be reduced even at a failure time of the linear motor 1. Accordingly, safety in the steering can be enhanced. This is because the thrust from the linear motor 1 is directly applied to the rack axis 303 with no deceleration mechanism or rotation/translation mechanism intervening therebetween in a mechanism-dependent manner.

Third, stability in the steering at a failure time of the assistance force can be enhanced. This is because the linear motor 1 is capable of generating the high damping even at the failure time.

Fourth, it becomes possible to discard a component such as rubber bush. Accordingly, a sense of steering felt by a driver who operates the steering wheel can be enhanced. This is because the linear motor 1 is capable of making a response by the thrust up to a high-frequency band, and thus is capable of suppressing the high-frequency vibration transmitted from the tires. Conventionally, the use of the component such as rubber bush has prevented the high-frequency vibration from being transmitted to the steering wheel.

Incidentally, in addition to the above-described embodiments illustrated in FIG. 21 and FIG. 22, it is conceivable that the linear motor according to the present invention is applied to an object of reducing, e.g., vehicle-body vibration of an automobile or vibration of a structure. This application of the linear motor makes it possible to expect implementation of effects, such as, e.g., being capable of enhancing the vibration-suppressing effect, accomplishing the small-sized implementation of the actuator, omitting damping components such as the damper, and simplifying the damping components.

It should be further understood by those skilled in the art that although the foregoing description has been made on embodiments of the invention, the invention is not limited thereto and various changes and modifications may be made without departing from the spirit of the invention and the scope of the appended claims.

1. A cylindrical linear motor, comprising:
a cylinder-shaped stator; and
a cylinder-shaped slider; said slider being deployed via a clearance with respect to said stator, and being linearly movable relative to said stator, wherein
said stator includes three-phase stator windings arranged sequentially in a movement direction of said slider, and a stator core deployed among these stator windings,
said slider including a slider core, and a plurality of permanent magnets fixed to said slider core and having poles with an equal spacing,
said stator core including a plurality of stator-core salient poles, two auxiliary poles, and yoke units, each of said stator-core salient poles having a plurality of small poles on its surface of side of said slider, said auxiliary poles being deployed at both ends of said stator-core salient poles, said yoke units configuring a magnetic circuit in cooperation with said stator core and said auxiliary poles,
said magnetic circuit configured by said stator core being shared among said three phases,
said plurality of permanent magnets of said slider being configured such that their polarities become an identical polarity, each of said plurality of permanent magnets being positioned at a position which is opposed to each of said plurality of small poles included in one stator-core salient pole out of said plurality of stator-core salient poles.

2. The cylindrical linear motor according to claim 1, wherein
said cylinder-shaped stator is deployed on inner-circumference side of said cylindrical linear motor, said cylinder-shaped slider being deployed on outer-circumference side thereof.

3. The cylindrical linear motor according to claim 1, wherein
at least said three or more small poles are deployed between said main poles of said stator.

4. The cylindrical linear motor according to claim 1, wherein
each of said auxiliary poles includes a magnetic notch portion on its clearance surface in an axial direction.

5. A cylindrical linear motor, comprising:
a cylinder-shaped stator; and
a cylinder-shaped slider; said slider being deployed via a clearance with respect to said stator, and being linearly movable relative to said stator, wherein
said stator includes three-phase stator windings arranged sequentially in a movement direction of said slider, and a stator core deployed among these stator windings,
said slider including a slider core, and a plurality of permanent magnets fixed to said slider core and having poles with an equal spacing,
said stator core including a plurality of stator-core salient poles, two auxiliary poles, and yoke units, each of said stator-core salient poles having a plurality of small poles on its surface of side of said slider, said auxiliary poles being deployed at both ends of said stator-core salient poles, said yoke units configuring a magnetic circuit in cooperation with said stator core and said auxiliary poles,
said magnetic circuit configured by said stator core being shared among said three phases,
a pitch of said plurality of small poles of said stator being so configured as to become equal to a pitch of said plurality of permanent magnets of said slider.

6. A cylindrical linear motor device, comprising:
a cylindrical linear motor including a cylinder-shaped stator and a cylinder-shaped slider, said slider being deployed via a clearance with respect to said stator, and being linearly movable relative to said stator;
a position sensor for detecting positions of poles of said slider deployed inside a magnetic circuit configured by a stator core; and
a control device for calculating said positions of said poles of said slider based on an output of said position sensor, and thereby controlling a current to be supplied to said cylindrical linear motor; wherein
said stator of said cylindrical linear motor includes three-phase stator windings arranged sequentially in a movement direction of said slider, and said stator core deployed among these stator windings,
said slider including a slider core, and a plurality of permanent magnets fixed to said slider core and having said poles with an equal spacing,
said stator core including a plurality of stator-core salient poles, two auxiliary poles, and yoke units, each of said stator-core salient poles having a plurality of small poles on its surface of said side of said slider, said auxiliary poles being deployed at both ends of said stator-core salient poles, said yoke units configuring said magnetic circuit in cooperation with said stator core and said auxiliary poles,
said magnetic circuit configured by said stator core being shared among said three phases,
said plurality of permanent magnets of said slider being configured such that their polarities become an identical polarity, each of said plurality of permanent magnets being positioned at a position which is opposed to each of said plurality of small poles included in one stator-core salient pole out of said plurality of stator-core salient poles.

7. The cylindrical linear motor device according to claim 6, wherein
said control device includes sensor-output information correction means for correcting said output from said position sensor based on a current value of a current control system with respect to said stator windings,
said sensor-output information correction means correcting said output information from said position sensor in accordance with sensor-output correction information for correcting said output information from said position sensor, and outputting, as corrected sensor-output information, said corrected output information to said control device,
said control device acquiring said information on said positions of said poles of said slider from said corrected sensor-output information, and thereby controlling said current to be supplied to said cylindrical linear motor.

8. The cylindrical linear motor device according to claim 6, wherein
said position sensor is deployed inside slits that are positioned between said plurality of respective small poles.

9. The cylindrical linear motor device according to claim 6, wherein
said position sensor is deployed inside slits that are positioned on clearance side of slots into which said stator windings are housed.

10. An electromagnetic suspension used in a vehicle, wherein
a cylindrical linear motor is used as said electromagnetic suspension,
said cylindrical linear motor, comprising:
a cylinder-shaped stator; and
a cylinder-shaped slider; said slider being deployed via a clearance with respect to said stator, and being linearly movable relative to said stator, wherein
said stator includes three-phase stator windings arranged sequentially in a movement direction of said slider, and a stator core deployed among these stator windings,
said slider including a slider core, and a plurality of permanent magnets fixed to said slider core and having poles with an equal spacing,
said stator core including a plurality of stator-core salient poles, two auxiliary poles, and yoke units, each of said stator-core salient poles having a plurality of small poles on its surface of side of said slider, said auxiliary poles being deployed at both ends of said stator-core salient poles, said yoke units configuring a magnetic circuit in cooperation with said stator core and said auxiliary poles,
said magnetic circuit configured by said stator core being shared among said three phases,
said plurality of permanent magnets of said slider being configured such that their polarities become an identical polarity, each of said plurality of permanent magnets being positioned at a position which is opposed to each of said plurality of small poles included in one stator-core salient pole out of said plurality of stator-core salient poles.

11. A motor-driven power steering device which uses a cylindrical linear motor as its power-source for assisting steering of a wheel,
said cylindrical linear motor, comprising:
a cylinder-shaped stator; and
a cylinder-shaped slider; said slider being deployed via a clearance with respect to said stator, and being linearly movable relative to said stator, wherein
said stator includes three-phase stator windings arranged sequentially in a movement direction of said slider, and a stator core deployed among these stator windings,
said slider including a slider core, and a plurality of permanent magnets fixed to said slider core and having poles with an equal spacing,
said stator core including a plurality of stator-core salient poles, two auxiliary poles, and yoke units, each of said stator-core salient poles having a plurality of small poles on its surface of side of said slider, said auxiliary poles being deployed at both ends of said stator-core salient poles, said yoke units configuring a magnetic circuit in cooperation with said stator core and said auxiliary poles,
said magnetic circuit configured by said stator core being shared among said three phases,
said plurality of permanent magnets of said slider being configured such that their polarities become an identical polarity, each of said plurality of permanent magnets being positioned at a position which is opposed to each of said plurality of small poles included in one stator-core salient pole out of said plurality of stator-core salient poles.

12. The cylindrical linear motor according to claim 1, wherein
said cylinder-shaped slider is coaxially deployed in a circumference of said cylinder-shaped stator, and is deployed movably in a longitudinal direction of said stator.
